(19) United States
(12) Patent Application Publication
(10) Pub. No.: US 2014/0029459 A1
(43) Pub. Date: Jan. 30, 2014

(54) APPARATUS AND METHOD FOR DISCONTINUOUS RECEPTION IN MULTIPLE COMPONENT CARRIER SYSTEM

(71) Applicant: Pantech Co., Ltd., Seoul (KR)

(72) Inventors: Ki Bum KWON, Seoul (KR); Jae Hyun AHN, Seoul (KR); Kang Suk HUH, Seoul (KR)

(73) Assignee: Pantech Co., Ltd., Seoul (KR)

(21) Appl. No.: 13/945,454

(22) Filed: Jul. 18, 2013

(30) Foreign Application Priority Data
Jul. 24, 2012 (KR) 10-2012-0080779

(51) Int. Cl. H04W 76/04

(52) U.S. Cl. CPC H04W 76/048
USPC 370/252; 370/280

(57) ABSTRACT

An apparatus and method for discontinuous reception in multiple component carrier system are provided. A method for a discontinuous reception (DRX) operation by a half-duplex UE in multiple component carrier system includes identifying whether a current subframe is a physical downlink control channel (PDCCH) subframe; perform PDCCH monitoring on the identified PDCCH subframe during an active time of a DRX cycle; and counting a DRX-related timer included in the active time in the identified PDCCH subframe.

### CROSS-REFERENCE TO RELATED APPLICATION

This application claims priority from and the benefit under 35 U.S.C. §119(a) of a Korean Patent Application No. 10-2012-0080779, filed on Jul. 24, 2012, which is incorporated by reference for all purposes as if fully set forth herein.

### BACKGROUND

1. Field

The present invention relates to wireless communication and, more particularly, to an apparatus and method for discontinuous reception in multiple component carrier system.

2. Discussion of the Background

In general, radio resources used in wireless communication are defined in a is frequency domain, a time domain, and a code domain. In wireless communication, a user equipment (UE) and a base station (BS) are supposed to use given radio resource, respectively. A wireless path for a UE to transmit a signal to a BS is known as uplink and a wireless path for a BS to transmit a signal to a UE is known as downlink. Meanwhile, a scheme for discriminating between radio resource used for downlink transmission and radio resource used for uplink transmission is required, which is known as a duplex scheme.

Like multiple access scheme for discriminating between different users, uplink and downlink may be discriminated in frequency, time, and code domains. The duplex scheme includes a half-duplex scheme according to which data transmission cannot be simultaneously performed and a full-duplex scheme according to which data transmission can be simultaneously performed. In the half-duplex scheme, while a UE (or a BS) is receiving data, the UE (or the BS) cannot transmit data, and while a UE (or a BS) is transmitting data, the UE (or the BS) cannot receive data. Namely, the half-duplex scheme provides only uni-directional communication for a particular period of time.

The full-duplex scheme includes an FDD (Frequency Division Duplex) scheme discriminating between uplink and downlink by frequency and the half-duplex scheme includes a TDD (Time Division Duplex) scheme discriminating between uplink and downlink by time.

In the FDD scheme, uplink and downlink are discriminated in a frequency domain, so data may be continuously transmitted between a BS and a UE in a time domain of each link. In general, the FDD scheme, which symmetrically configures frequency bands to be allocated to uplink and downlink, is appropriate for a symmetric service such as a voice call. However, frequency bands of respective links configured according to the FDD scheme are required to be spaced apart from each other by a predetermined frequency due to interference is between links, causing some frequency resources to be unavailable. Also, frequency bands allocated to the respective links cannot be substantially changed. Thus, in an asymmetric service, such as file transmission or an Internet service, in which an amount of radio resources required for each link may be changed over time, radio resources used in downlink and uplink in a wireless transmission/reception system are determined in advance, so the FDD scheme has limitation in efficiency.

In comparison, in the case of the TDD scheme, time slots having different ratios can be allocated to uplink and downlink, having an advantage in that it is appropriate for an asymmetric service. Another advantage of the TDD scheme is that uplink and downlink are transmitted and received in the same frequency band, channel states of uplink and downlink are substantially identical. Thus, on the basis of a received signal, a state of a channel to be transmitted to a device, which has transmitted the signal, can be immediately estimated, so the TDD scheme is appropriate for an array antenna technique, or the like. However, in the TDD scheme, entire frequency bands are used for uplink or downlink, and uplink and downlink are discriminated in a time domain. Thus, if time synchronization is not matched for transmission and reception in each device, unintentional interference signals are generated between devices, degrading performance.

A multiple component carrier system refers to a wireless communication system capable of supporting carrier aggregation. Carrier aggregation, a technique for effectively using fragmented small bands, aims at obtaining an effect, as if a logically large band is used, by grouping a plurality of physically non-continuous bands in a frequency domain. A multiple component carrier system supports aggregation of a plurality of component carriers (CCs) differentiated in a frequency domain. CCs include an uplink CC used in uplink and a downlink CC used in downlink. Downlink CCs and uplink CCs may be united to constitute a serving cell. Alternatively, a single serving cell may also be constituted only with downlink CCs.

In the TDD scheme, when serving cells of the same band are aggregated, the same uplink and downlink configuration is allocated to each serving cell. The reason is because, a frequency separation between serving cells in a band is close, so if different uplink and downlink configurations are allocated to each serving cell, uplink and downlink operations are performed at the same point in time, causing interference between serving cells. Meanwhile, serving cells of different bands are aggregated, a frequency separation sufficient not to cause interference is secured for different bands, so different TDD uplink and downlink configurations can be allocated to each serving cell.

However, in the related art, since PDCCH subframes with respect to a half-duplex UE operation and a full-duplex UE operation are not defined from a vantage point of a plurality of serving cells, UE's PDDCH monitoring and DRX operation performing method are not clear.

### SUMMARY

The present invention provides an apparatus and method for discontinuous reception on the basis of a half-duplex UE operation in a multiple component carrier system.

The present invention also provides a reference for counting an active time in a case in which a plurality of serving cells are configured in a UE.

The present invention also provides an apparatus and method for performing a discontinuous reception operation on the basis of a concept of a PDCCH subframe defined from a vantage point of a plurality of serving cells in a half-duplex UE operation.

In an aspect, a method for a discontinuous reception (DRX) operation by a half duplex user equipment (UE) in multiple component carrier system is provided. The method includes identifying whether a current subframe is a physical downlink control channel (PDCCH) subframe; perform PDCCH monitoring on the identified PDCCH subframe during an active time of a DRX cycle; and counting a DRX-related timer included in the active time in the identified PDCCH subframe.

When a high priority uplink (UL) signal is transmitted in the current subframe in at least one of all serving cells configured in the UE, the current subframe may be determined not to be the PDCCH subframe.

In another aspect, a half-duplex UE performing a DRX (discontinuous reception) operation in a multiple component carrier system is provided. The UE includes a DRX operation controller configured to identify whether a current subframe is a physical downlink control channel (PDCCH) subframe, perform PDCCH monitoring on the identified PDCCH subframe during an active time of a DRX cycle, and count a DRX-related timer included in the active time in the identified PDCCH subframe; and a reception unit configured to receive a PDCCH from a base station (BS) to perform PDCCH monitoring.

When a high priority uplink (UL) signal is transmitted in the current subframe in at least one of all serving cells configured in the UE, the DRX operation controller may determine that the current subframe is not the PDCCH subframe.

### BRIEF DESCRIPTION OF THE DRAWINGS

FIG. 1 is a view illustrating a wireless communication system to which the present invention is applied.

FIG. 2 is an example of a radio frame structure to which the present invention is is applied.

FIG. 3 is a view illustrating a state of serving cells configured in a UE in a multiple component carrier system according to an embodiment of the present invention.

FIG. 4 is a view illustrating a difference between TDD uplink and downlink configurations of serving cells in inter-band carrier aggregation according to an embodiment of the present invention.

FIG. 5 is a view illustrating a DRX (discontinuous reception) operation to which the present invention is applied.

FIG. 6 is a view illustrating an operation of performing counting of an on-duration timer by a UE according to an embodiment of the present invention.

FIG. 7 is a view illustrating an operation of performing counting of an on-duration timer by a UE according to another embodiment of the present invention.

FIG. 8 is a view illustrating an operation of performing counting of an on-duration timer by a UE according to another embodiment of the present invention.

FIG. 9 is a view illustrating an operation of performing counting of a DRX retransmission timer by a UE according to an embodiment of the present invention.

FIG. 10 is a view illustrating an operation of performing counting of a DRX retransmission timer by a UE according to another embodiment of the present invention.

FIG. 11 is a view illustrating an operation of performing counting of a DRX retransmission timer by a UE according to another embodiment of the present invention.

FIG. 12 is a view illustrating an operation of performing counting of a DRX retransmission timer by a UE according to another embodiment of the present invention.

FIG. 13 is a view illustrating an operation of performing counting of a DRX is retransmission timer by a UE according to another embodiment of the present invention.

FIG. 14 is a view illustrating an operation of performing counting of a DRX retransmission timer by a UE according to another embodiment of the present invention.

FIG. 15 is a signaling flow chart between a UE and a base station (BS) according to an embodiment of the present invention.

FIG. 16 is a flow chart illustrating a DRX operation performed by a UE according to an embodiment of the present invention.

FIG. 17 is a flow chart illustrating a DRX operation performed by a UE according to another embodiment of the present invention.

FIG. 18 is a flow chart illustrating a DRX operation performed by a BS according to an embodiment of the present invention.

FIG. 19 is a block diagram of a UE and a BS performing a DRX operation according to an embodiment of the present invention.

### DETAILED DESCRIPTION OF THE ILLUSTRATED EMBODIMENTS

Hereinafter, in the present disclosure, some embodiments will be described in detail with reference to the accompanying drawings, in which like numbers refer to like elements throughout although they are shown in different drawings. In describing the present invention, if a detailed explanation for a related known function or construction is considered to unnecessarily divert the gist of the present invention, such explanation will be omitted but would be understood by those skilled in the art.

In the present disclosure, a wireless communication network will be described, and an operation performed in the wireless communication network may be performed in a is process of controlling a network and transmitting data by a system (e.g., a base station (BS)) administering the corresponding wireless communication network or may be performed in a user equipment (UE) connected to the corresponding wireless network.

According to embodiments of the present invention, meaning of ‘transmitting a control channel’ may be construed as ‘transmitting control information via a particular channel. Here, the control channel may be, for example, a PDCCH (Physical Downlink Control Channel) or a PUCCH (Physical Uplink Control Channel).

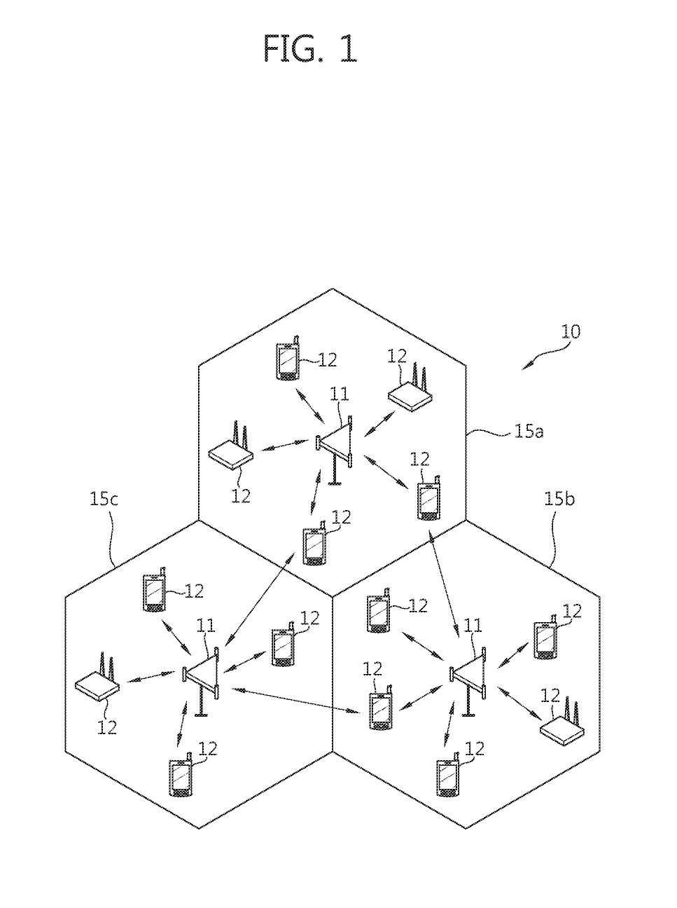

FIG. 1 is view illustrating a wireless communication system to which the present invention is applied.

Referring to FIG. 1, a wireless communication system 10 is widely disposed to provide various communication services such as voice and packet data, or the like. The wireless communication system 10 includes at least one base station (BS). Each BS 11 provides a communication service to particular cells 15a, 15b, and 15c. The cells may be divided into a plurality of areas (which are generally called sectors). The BS 11 may be called by other names such as evolved-node B (eNB), base transceiver system (BTS), access point (AP), a femto BS, a home nodeB, a relay, etc. Cells 15a, 15b, and 15c may be construed to include various coverage areas such as a mega-cell, a macro-cell, a micro-cell, a pico-cell, a femto-cell, small-cell and the like.

A user equipment (UE) 12 may be fixed or mobile and may be referred to by other names such as mobile station (MS), mobile terminal (MT), user terminal (UT), subscriber station (SS), wireless device, personal digital assistant (PDA), wireless modem, handheld device, etc.

Hereinafter, downlink refers to a transmission link from the BS 11 to the UE 12, and uplink (UL) refers to a transmission link from the UE 12 to the BS 11. In downlink, a transmitter may be a part of the BS 11 and a receiver may be a part of the UE 12. In uplink, a transmitter may be a part of the UE 12 and a receiver may be a part of the BS 11. Multiple access schemes applied to the wireless communication system are not limited. Namely, various multi-access schemes such as CDMA Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used. For uplink transmission and downlink transmission, a TDD (Time Division Duplex) scheme in which transmission is made by using a different time or an FDD (Frequency Division Duplex) scheme in which transmission is made by using different frequencies may be used.

Carrier aggregation (CA) supports a plurality of carriers, which is also called a spectrum aggregation or a bandwidth aggregation. Carrier aggregation is introduced to support increased throughput, prevent an increase in cost otherwise caused by an introduction of a broadband radio frequency (RF) element, and guarantee compatibility with an existing system. For example, when five component carriers are allocated as granularity of carrier unit having a 5 MHz bandwidth, a maximum 25 MHz bandwidth can be supported.

The carrier aggregation can be divided into a contiguous carrier aggregation made among component carriers consecutive in a frequency domain and a non-contiguous carrier aggregation made among component carriers inconsecutive the frequency domain. An aggregation in which the number of downlink component carriers is equal to the number of uplink component carriers is called a symmetric aggregation, and an aggregation in which the number of downlink component carriers is equal to the number of uplink component carriers is is called an asymmetric aggregation.

Sizes (i.e., bandwidths) of component carriers may vary. For example, when five component carriers are used to configure a 70 MHz band, the five carriers may be configured as follows: 5 MHz carrier (carrier #0)+20 MHz carrier (carrier #1)+20 MHz carrier (carrier #2)+20 MHz carrier (carrier #3)+5 MHz carrier (carrier #4).

Hereinafter, a multiple component carrier system refers to a system supporting carrier aggregation. In the multiple component carrier system, contiguous carrier aggregation and/or non-contiguous carrier aggregation may be used, or any of the symmetrical aggregation and the asymmetrical aggregation may be used.

A serving cell may be defined by component frequency bands that may be aggregated by carrier aggregation on the basis of the multiple component carrier system. The serving cell may include a primary serving cell (Pcell) and a secondary serving cell (SCell). The primary serving cell refers to a serving cell providing security input and NAS mobility information in an RRC connected (or established) state or a re-connected (or re-established) state. According to capabilities of a UE, at least one cell may be configured to form a set of serving cells together with a primary serving cell, and here, the at least one cell is called a secondary serving cell. A set of serving cells configured in a UE may include only one primary serving cell, or may include one primary serving cell and at least one secondary serving cell.

A primary serving cell is constantly activated, while a secondary serving cell is activated/deactivated according to a particular condition. The particular condition may be a case in which an activation/deactivation indicator from a BS is received or a case in which a deactivated timer within a UE has expired. Activation refers to a state in which traffic data is transmitted or received, or is ready. Deactivation refers to a state in which traffic data and control is information with respect to the traffic data cannot be transmitted or received and only measurement or transmission/reception of minimum information is available.

A downlink component carrier corresponding to a primary serving cell is called a downlink primary component carrier (DL PCC), and an uplink component carrier corresponding to a primary serving cell is called an uplink primary component carrier (UL PCC). Also, in downlink, a component carrier corresponding to a secondary serving cell is called a downlink secondary component carrier (DL SCC), and in uplink, a component carrier corresponding to a secondary serving cell is called an uplink secondary component carrier (UL SCC). To a single serving cell, only a DL CC may correspond or both DLCC and UL CC may correspond.

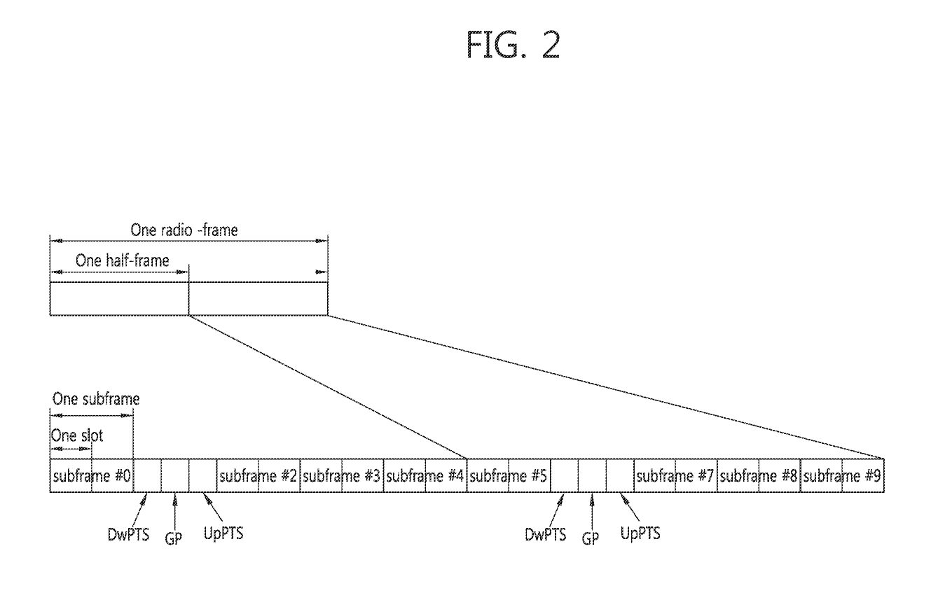

FIG. 2 is an example of a radio frame structure to which the present invention is applied. Specifically, FIG. 2 illustrates a TDD radio frame structure.

Referring to FIG. 2, a radio frame includes two half frames. The two half frames have the same structure. Each half frame includes five subframes, DwPTS (Downlink Pilot Time Slot), GP (Guard Period), and UpPTS (Uplink Pilot Time Slot). DwPTS is used for initial cell searching, synchronization, or channel estimation in a UE. UpPTS is used for channel estimation and synchronization of uplink transmission of a UE in a BS. GP is a period for canceling interference generated in uplink due to multi-path delay in a downlink signal between uplink and downlink.

Table 1 shows an example of TDD UL/DL configuration of a radio frame. The TDD UL/DL configuration defines subframes reserved for uplink transmission and subframes reserved for downlink transmission in one TDD radio frame. Namely, the TDD UL/DL configuration provides information regarding under which rule uplink and downlink are allocated (or reserved) to respective subframes of one TDD radio frame.

TABLE 1

| UL/DL | Switching | | | | | | | | | | |
|---|---|---|---|---|---|---|---|---|---|---|---|
| configura- | point | Subframe No. | | | | | | | | | |
| tion | period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 1, ‘D’ represents that a subframe is used for DL transmission, and ‘U’ represents that a subframe is used for UL transmission. ‘S’ is a special subframe, which represents that a subframe is used for a special purpose and represents that a subframe is used for frame synchronization or downlink transmission. For example, a special subframe may include DwPTS, GP, and UpPTS. Hereinafter, a subframe allocated for downlink transmission will be simply referred to as a downlink subframe and a subframe allocated for uplink transmission will be simply referred to as an uplink subframe. In each TDD UL/DL configuration, positions and number of DL subframes and UL subframes are different in one TDD radio frame.

A point in time at which downlink is switched to uplink or a point in time at which uplink is switched to downlink is called a switching point. Switching point periodicity refers to a period by which an aspect in which an uplink subframe and a downlink subframe are switched is uniformly repeated, which is 5 ms or 10 ms. For example, in the TDD UL/DL configuration 0, 0^{th} to 4^{th} subframes are switched from D->S->U->U->U and 5^{th} to 9^{th} subframes are switched from D->S->U->U->U in the same manner. Since one subframe is 1 ms, switching is point periodicity is 5 ms. Namely, switching point periodicity is smaller than the length 10 ms of one radio frame, and an aspect of switching in a radio frame is repeated once.

The TDD UL/DL configuration of Table 1 may be transmitted from a BS to a UE through system information. Whenever the TDD UL/DL configuration is changed, the BS may transmit only an index of a changed TDD UL/DL configuration to inform the UE about the change in an UL/DL ALLOCATION STATE OF A RADIO FRAME. Alternatively, the TDD UL/DL configuration may be control information, as broadcast information, commonly transmitted to every UE within a cell through a broadcast channel.

The multiple component carrier system operates a plurality of serving cells such as a primary serving cell and/or a secondary serving cell, and the like. A TDD UL/DL configuration of a primary serving cell defines a UL subframe and a DL subframe of a primary serving cell. A TDD UL/DL configuration of a secondary serving cell defines a UL subframe and a DL subframe of a secondary serving cell. Thus, a plurality of serving cells configured in a UE may independently have a TDD UL/DL configuration. This may be referred to as a cell-specific TDD UL/DL configuration. For example, in Table 1, it is assumed that a TDD UL/DL configuration of a primary serving cell is #2 and a TDD UL/DL configuration of a secondary serving cell is #5. Here, #7 subframe is a UL subframe with respect to a primary serving cell but it is a DL subframe with respect to a secondary serving cell.

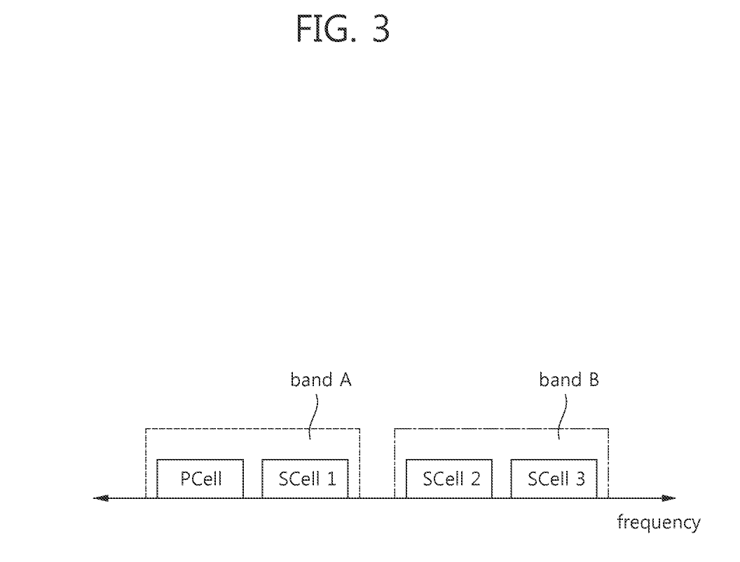

FIG. 3 is a view illustrating a state of serving cells configured in a UE in a multiple component carrier system according to an embodiment of the present invention.

Referring to FIG. 3, a system bandwidth includes a Band A and a Band B. The is band A includes a primary serving cell PCell and a first secondary serving cell SCell 1. The band B includes a second secondary serving cell Scell 2 and a third secondary serving cell SCell 3. Carrier aggregation (CA) of the primary serving cell and the first secondary serving cell is intra-band A aggregation. Similarly, CA of the second secondary serving cell and the third secondary serving cell is intra-band B aggregation. Meanwhile, CA of the first secondary serving cell and the second secondary serving cell or CA of the primary serving cell and the second secondary serving cell, or CA of the primary serving cell and the third secondary serving cell is inter-band aggregation. Also, CA of the first secondary serving cell and the third secondary serving cell is also inter-band aggregation. In the case of intra-band aggregation, all serving cells in the same band should have the same TDD UL/DL configuration, but in the case inter-band CA, serving cells in different bands may have different TDD UL/DL configurations. Different TDD UL/DL configurations between serving cells are not problematic when a UE supports a full-duplex mode, but problematic when a UE supports only a half-duplex mode.

In the inter-band aggregation, different TDD UL/DL configurations between serving cells may be required in order to avoid interference with any other coexisting TDD system such as TDS-CDMA, WiMAX, or the like, in the same band. Also, application of TDD UL/DL configuration including more UL subframes to a low frequency band and application of a TDD UL/DL configuration including more DL subframes to a high frequency band help expand coverage and affect peak throughput.

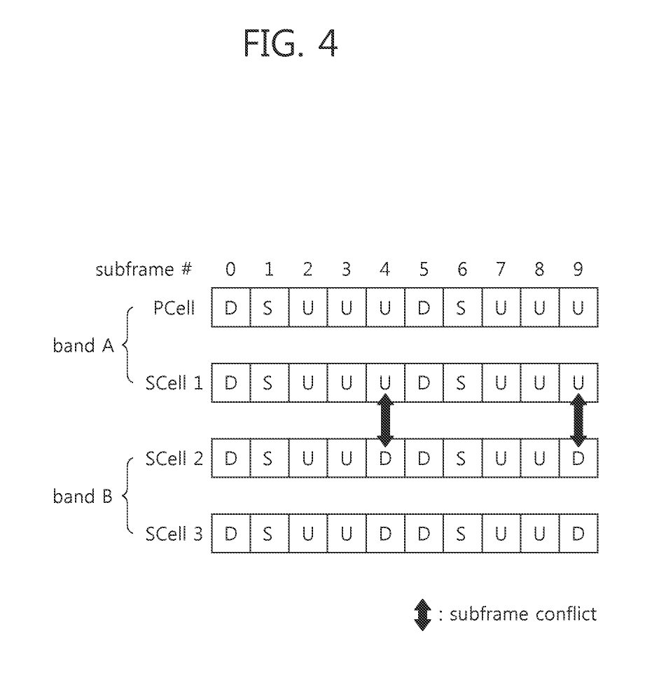

FIG. 4 is a view illustrating a difference between TDD uplink and downlink configurations of serving cells in inter-band carrier aggregation according to an embodiment of the present invention. This will be described on the basis of FIG. 3.

Referring to FIG. 4, the same TDD UL/DL configuration is applied to serving is cells included in the same band and TDD UL/DL configuration is independently applied to different bands. Such a TDD UL/DL configuration is called a band-specific TDD UL/DL configuration. For example, the TDD UL/DL configuration 0 is applied to both the primary serving cell PCell and the first secondary serving cell SCell 1 included in the band A, and the TDD UL/DL configuration 1 is applied to both the second secondary serving cell SCell 2 and the third secondary serving cell SCell3 included in the band B.

For example, when CA is made between the first secondary serving cell and the second secondary serving cell, it is inter-band CA. Of course, CA of the primary serving cell and the second secondary serving cell, CA of the primary serving cell and the third secondary serving cell, and CA of the first secondary serving cell and the third secondary serving cell are also inter-band aggregation. As for a TDD UL/DL configuration of the first secondary serving cell and the second secondary serving cell, #4 and #9 subframes are UL subframes with respect to the first secondary serving cell, while these are DL subframes with respect to the second secondary serving cell. In terms of the TDD UL/DL configuration, subframe conflict or subframe inconsistency occurs in #4 and #9 subframes. Subframe conflict refers to a situation in which subframe transmission directions are difference in two or more compared serving cells, and #4 and #9 subframes are conflicting subframes.

An operation of a UE is different over subframe conflict according to a duplex mode. For example, in case of a full-duplex mode, a UE may perform UL transmission in the primary serving cell (and/or the first secondary serving cell) and DL reception in the second secondary serving cell (and/or the third secondary serving cell) in the #4 subframe. Similarly, a UE may perform UL transmission in the primary serving cell (and/or the first secondary serving cell) and DL reception in the second secondary serving cell (and/or the third secondary serving is cell) in the #9 subframe. Meanwhile, in a case of a half-duplex mode, communication can be performed only in any one direction, so a UE selects any one serving cell among the primary serving cell (and/or the first secondary serving cell) and the second secondary serving cell (and/or the third secondary serving cell) in the #4 subframe and performs communication with a BS on the basis of a communication direction in the selected serving cell. For example, in a case in which DL has higher priority than UL or in a case in which priority of the second secondary serving cell is higher than any other serving cells, a UE may perform DL reception on the second secondary serving cell in the #4 subframe and does not perform UL transmission. Meanwhile, in a case in which UL has higher propriety than DL or in a case in which priority of the primary serving cell or the first secondary serving cell higher than those of other serving cells, a UE performs UL transmission on the second secondary serving cell in the #4 subframe and does not perform DL reception.

Similarly, the UE selects any one serving cell among the primary serving cell (and/or the first secondary serving cell) and second secondary serving cell (and/or the third secondary serving cell) in the #9 subframe and performs communication with a BS on the basis of a communication direction in the selected serving cell. Since the other remaining subframes excluding #4 and #9 subframes are configured in the same direction, so the UE may perform communication through all the secondary serving cells, without having to select any one serving cell.

Information regarding which link direction is to be preferentially selected in the conflicting subframes to perform communication may be provided by the BS to the UE in advance. In another example, a corresponding wireless communication system may fixedly determine link priority in all the conflicting frames in advance. In another example, a corresponding wireless communication system may fixedly determine a serving cell as a reference of link priority in all the conflicting subframes in advance. The serving cell may be, for example, a primary serving cell.

The UE may perform monitoring on a PDCCH on the basis of a UE-specific identifier, e.g., a C-RNTI (cell-radio network temporary identifier), an SPS (semi persistent scheduling) C-RNTI, and TPC (transmission power control)-PUCCH-RNTI or TPC-PUSCH-RNTI shared with a plurality of UEs. Monitoring of a PDCCH scrambled with one of the RNTIs may be controlled by a DRX (discontinuous reception) operation. The BS transmits a DRX-related parameter to the UE through an RRC message. The UE should constantly receive the PDCCH scrambled with the SI-RNTI (system information-RNTI) and the P-RNTI (paging-RNTI) regardless of a DRX operation. Here, the other remaining PDCCHs excluding the PDCCH scrambled with the C-RNTI are received through a common search space in a DL PCC of a primary serving cell.

When a DRX-related parameter is configured in the UE, the UE performs discontinuous monitoring on the PDCCH on the basis of the DRX operation. Meanwhile, when a DRX-related parameter is not configured in the UE, the UE performs continuous monitoring on the PDCCH. Discontinuous PDCCH monitoring may refer to monitoring a PDCCH by the UE only in a predefined particular subframe among subframes in which a PDCCH may be received, and continuous PDCCH monitoring may refer to monitoring a PDCCH in all the subframes in which the PDCCH can be received. Meanwhile, when PDCCH monitoring is required in an operation irrespective of DRX such as a random access procedure, the UE monitors a PDCCH according to requirements of the corresponding operation.

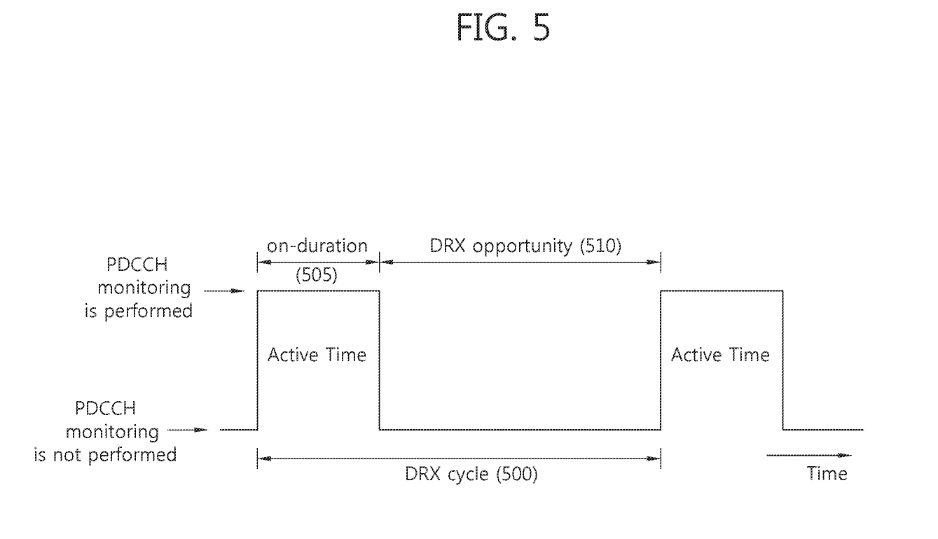

FIG. 5 is a view illustrating a DRX operation to which the present invention is is applied.

Referring to FIG. 5, a DRX operation is repeated by DRX cycle 500. The DRX cycle 500 is defined by periodic repetition of on-duration 505 that follows a interval available for inactivity. One period of the DRX cycle 500 includes the on-duration 505 and an opportunity for DRX 510. An RRC layer manages some timers for controlling a DRX operation. The timers for controlling the DRX operation includes an on-duration timer (on DurationTimer), a DRX inactivity timer (drxlnactivity Timer), and a DRX retransmission timer (drxRetransmission Timer).

A time during which the on-duration timer, the DRX inactivity timer, and the DRX retransmission timer are running is called an active time. Alternatively, the active time may refer to every interval during which a UE is awake. With the DRX cycle 500 configured, the active time includes running time of the on-duration timer, the DRX inactivity timer, and the DRX retransmission timer. The UE monitors a PDCCH in a PDCCH subframe during the active time. Here, the PDCCH subframe should not be a portion of a configured measurement gap.

A DRX operation is performed on a serving cell configured in a UE and activated. Also, a single DRX operation is applied to all the serving cells. Namely, a DRX operation is not separately performed on each serving cell but a UE performs a DRX operation for all the serving cells on the basis of one DRX cycle, DRX parameter, and timer. Thus, all the serving cells configured and activated in the UE have the same active time.

Besides, parameters for controlling a DRX operation include a long DRX cycle (longDRX-Cycle) and a DRX start offset (drxStartOffset), and the BS may selectively set a DRX short cycle timer (drxShortCycleTimer) and a short DRX cycle (shortDRX-Cycle). Also, a hybrid automatic repeat request (HARQ) round trip time (RTT) timer is defined in every downlink HARQ process.

The DRX start offset is a value regulating a subframe from which the DRX cycle 500 starts. The DRX short cycle timer is a timer defining the number of continuous subframes that the UE surely follows the short DRX cycle. The HARQ RTT timer is a timer defining a minimum number of subframes before a interval in which DL HARQ retransmission by the UE is expected.

In the wireless communication system operating multiple component carriers, when a UE has different TDD UL/DL configurations for respective serving cells, it affects a DRX operation, as well as causing the problem of conflicting subframes. Thus, for a DRX operation, operational references with respect to each timer configured by a BS should be clearly defined.

First, an on-duration timer as a DRX-related timer will be described in detail. The on-duration timer fundamentally specifies the number of consecutive PDCCH subframes from a point in time at which a DRX cycle starts. Namely, a start point in time of the on-duration timer is consistent with a start point in time of the DRX cycle. An on-duration timer value expires when it is equal to a pre-set first expiration value. Until when the on-duration timer value is equal to the first expiration value, the UE may validly run the timer. As described above, the active time includes a time during which the on-duration timer is running.

Next, the DRX inactivity timer as a DRX-related timer will be described in detail. The DRX inactivity timer may be defined by the number of consecutive PDCCH subframes from a point in time at which PDCCHs for UL or DL user data transmission are successfully decoded. Since another data may be continuously transmitted, the UE should continuously monitor PDCCHs for the data when the DRX inactivity timer is running. The DRX inactivity timer starts is or restarts when the UE successfully decodes PDCCHs with respect to initial HARQ transmission for a HARQ process in a PDCCH subframe. Therefore, the DRX inactivity timer can start or restart at next subframe of the PDCCH subframe. In order to monitor PDCCHs, the UE should enter the active time during the DRX operation. Thus, in order for the DRX inactivity timer to start, the UE is required to enter the active time by the on-duration timer, or the like, a PDCCH subframe is required to exist, and PDCCH decoding is required to be successful. Until before the DRX inactivity timer value is equal to a second expiration value, the UE may validly run the DRX inactivity timer.

Next, the DRX retransmission timer as a DRX-related timer will be described in detail. The DRX retransmission timer is a timer that operates on the basis of a maximum value of the consecutive PDCCH subframe(s) until a DL retransmission is received by the UE. The DRX retransmission timer for a HARQ process starts in a case in which data in the HARQ process was not successfully decoded when the HARQ RTT timer expired. The DRX retransmission timer is running to monitor PDCCH for retransmission data until PDCCH related to a DL transmission for the HARQ process is received or the DRX retransmission timer is expired That is, The UE may monitor receiving of data retransmitted in the HARQ process while the DRX retransmission timer is running. Setting of the DRX retransmission timer is defined by a MAC-MainConfig message of an RRC layer.

A value of the DRX retransmission timer is increased by 1 each time whenever predetermined conditions are met, and the DRX retransmission timer expires when its value is equal to a pre-set third expiration value. Until before the value of the DRX retransmission timer is equal to the third expiration value, the DRX retransmission timer is validly running or stopped according to circumstances.

In this manner, counting of the DRX-related timer depends upon a PDCCH subframe, so, a PDCCH subframe is defined as follows. A PDCCH subframe may be defined by the serving cell or by the UE.

Subframe Defined by the Serving Cell

For example, in a single carrier system, a PDCCH subframe may be defined by a subframe with a PDCCH. In detail, in a full-duplex UE scheme, a PDCCH may be transmitted in every subframe, so all the subframes may become PDCCH subframes. Also, in a half-duplex UE scheme, since a PDCCH is transmitted via a downlink subframe, a downlink subframe may be included in a PDCCH subframe. Also, a special subframe including a DwPTS interval may also be included in a PDCCH subframe.

In another example, in a multiple component carrier system supporting a plurality of serving cells, a PDCCH subframe may be defined by the serving cell. This is because PDCCHs are independently transmitted in each serving cell. A full-duplex UE operation or a half-duplex UE operation is no different. For example, in a full-duplex UE operation, in a case in which a PDCCH1 is transmitted in a first serving cell, a PDCCH 2 is transmitted in a second serving cell, and any PDCCH is not transmitted in a third serving cell in a certain subframe k, the subframe k is a PDCCH subframe with respect to the first and second serving cells, but it is not a PDCCH subframe with respect to the third serving cell. Namely, in spite of the same subframe, each serving cell may be a PDCCH subframe or may not be a PDCCH subframe.

In a multi-serving cell environment, a concept of a scheduling cell may be used to more effectively define a PDCCH subframe. A scheduling cell is a serving cell in which the UE may be able to receive a PDCCH. Or, a scheduling cell is a serving cell in which a PDCCH for itself or a different serving cell is transmitted. Having the counter concept, a non-scheduling cell is a serving cell in which the UE cannot receive a PDCCH. Or, a non-scheduling cell is a serving cell in which a PDCCH for itself or a different serving cell is not transmitted. In case of self-scheduling, all serving cells are scheduling cells and only information regarding each serving cell can be received. However, in a case in which cross-carrier scheduling is enabled, scheduling cells may be limited only to some designated serving cells (e.g., a primary serving cell). Here, the scheduling cell may include scheduling information regarding a non-scheduling cell. The UE may receive configuration information indicating a scheduling cell from the BS. For example, the primary serving cell becomes a scheduling cell all the time and does not have any other scheduling cell than itself. Also, a secondary serving cell may become a scheduling cell only when indicated by the BS.

In a half-duplex operation, e.g., in a TDD UE operation, even when TDD UL/DL configurations are different in each serving cell, a PDCCH subframe may be separately defined in each serving cell. For example, in case of FIG. 4, the subframe #4 is a UL subframe with respect to the primary serving cell and the first secondary serving cell and is a DL subframe with respect to the second secondary serving cell and the third secondary serving cell. Thus, the subframe #4 is not a PDCCH subframe with respect to the primary serving cell and the first secondary serving cell and is a PDCCH subframe with respect to the second secondary serving cell and the third secondary serving cell.

In this manner, in spite of the same subframe, it may be a PDCCH subframe with respect to a certain serving cell or may not be a PDCCH subframe with respect to any other serving cell. Namely, PDCCH subframe is separately, independently defined for each serving cell. In comparison to the definition of the PDCCH subframe, a PDCCH subframe may be defined uniformly with respect to all serving cells, which is called a PDCCH subframe defined by the UE.

Subframe Defined by UE—Key Uplink Subframe Considered

In a half-duplex UE operation, a PDCCH subframe may be defined as a union of DL subframes and a special subframes in all serving cells. Namely, when a DL subframe or a special subframe exists in at least one serving cell, the corresponding subframe is a PDCCH subframe. Except for an exceptional case, a UL subframe is not considered in determining a PDCCH subframe. Here, an exceptional case refers to a case in which at least one key UL subframe exists. In the exceptional case, although a DL subframe or a special subframe exists, a PDCCH subframe is not defined. Since an exception by a key UL subframe is admitted, it is defined as a PDCCH subframe considering a key UL subframe.

For example, in FIG. 4, it is assumed that three serving cells of the first secondary serving cell, the second secondary serving cell, and the third secondary serving cell are configured in a half-duplex UE through CA. Regarding the fourth subframes, they are conflicting subframes, but a union between the DL subframe of the second secondary serving cell and the DL subframe of the third secondary serving cell may be defined as a PDCCH subframe. Here, however, if the UL subframe of the first secondary serving cell is a key UL subframe, it is an exceptional case, so the subframe #4 is not a PDCCH subframe.

A key UL subframe refers to a UL subframe used for transmission of a UL signal regarded as being important in a half-duplex UE operation. A key UL subframe refers to a UL subframe having precedence over a DL subframe. Although there is a subframe conflict, in case of a key UL subframe, a half-duplex UE performs UL transmission, instead of DL reception. Namely, a key UL subframe serves as a key in determining or switching a transmission/reception direction of a half-duplex UE. In the foregoing example, when a UL subframe of the first is secondary serving cell is a key UL subframe, the UE performs UL transmission in the first secondary serving cell, rather than performing downlink reception in the second and third secondary serving cells. In this manner, admission of an exception by a key UL subframe in the definition of a PDCCH subframe aims at solving a problem that an important UL signal is inhibited from being transmitted just because it is a PDCCH subframe

A UL subframe regarded as a key UL subframe is as follows.

(1) UL Subframe of Primary Serving Cell

In a case in which a conflicting subframe is a UL subframe with respect to a primary serving cell, the UL subframe is a key UL subframe. Namely, the key UL subframe includes a UL subframe with respect to the primary serving cell. In this case, the conflicting subframe is not a PDCCH subframe. In other words, if the conflicting subframe is a PDCCH subframe, a subframe with respect to the primary serving cell is a DL subframe or a special subframe including a DwPTS interval.

(2) UL Subframe for High Priority UL Signal

A high priority UL signal refers to a UL signal having priority higher than that of a downlink signal. For example, a UL signal transmitted according to the needs of a BS or a UL signal retransmitted by a UE is of high importance. Thus, a UL subframe for a high priority UL signal is a key UL subframe. In other words, a key UL subframe includes a UL subframe for a high priority UL signal. The high priority UL signal is essential, so a UE transmits the UL signal without defining union of DL subframe(s) conflicting with the key UL subframe and/or special subframe(s), as a PDCCH subframe (namely, the UE does not receive a DL signal).

For example, the high priority UL signal includes a sounding reference signal (SRS). Namely, a UL subframe for transmission of SRS is classified as a key UL subframe.

In the half-duplex UE operation, when at least one UL subframe with respect to a plurality of serving cells serves to transmit an aperiodic SRS (ASRS), the union of DL subframe(s) conflicting with at least one UL subframe and/or special subframe(s) is not a PDCCH subframe. This is because, transmission of an ASRS is an operation controlled by a BS, having high priority. Here, the ASRS may be transmitted in a primary serving cell or a secondary serving cell initialized according to an instruction from the BS.

However, in a case in which transmission of the ASRS is performed through a special subframe, the special subframe may be a PDCCH subframe. The reason is because, the special subframe includes a DwPTS interval and a UpPTS interval, and here, even a half-duplex UE can monitor a PDCCH during the DwPTS interval and transmit an SRS during the UpPTS of the same subframe. Namely, the UE does not need to sacrifice any one of transmission of an SRS and monitoring of a PDCCH. In the aspect that the special subframe for receiving at least one PDCCH exists, the special subframe may be defined as a PDCCH subframe.

In another example, a high priority UL signal includes a physical random access channel (PRACH). Namely, a UL subframe for PRACH transmission is classified as a key UL subframe.

In the half-duplex UE operation, when at least one UL subframe with respect to a plurality of serving cells serves for PRACH transmission, a union of DL subframe(s) conflicting with the at least one UL subframe and/or special subframe(s) is not a PDCCH subframe. This is because PRACH transmission in a secondary serving cell is an operation controlled by a BS, having high priority. Here, the PRACH may be transmitted in a primary serving cell or a secondary serving cell initialized according to an instruction of the BS.

However, when the PRACH transmission is performed through a special subframe, the special subframe may be a PDCCH subframe. For example, as shown in Table 2 below, formats 0 to 4 of preambles mapped to a PRACH are supported.

TABLE 2

| Preamble format | T_{CP} | T_{SEQ} |
|---|---|---|
| 0 | 3168T_{S} | 24576T_{S} |
| 1 | 21024T_{S} | 24576T_{S} |
| 2 | 6240T_{S} | 2•24576T_{S} |
| 3 | 21024T_{S} | 2•24576T_{S} |
| 4 | 448T_{S} | 4096T_{S} |

Referring to Table 2, T_{CP} is a parameter indicating a CP interval of a cyclic prefix (CP) of a PRACH symbol, T_{SEQ} is a parameter indicating a sequence interval, and T_{S} indicates a sampling time. If a UE uses a preamble according to format 4 and a BS instructs the UE to transmit PRACH through a special subframe, the UE may transmit a PRACH during a UpPTS interval and monitor a PDCCH during a DwPTS interval. Thus, the special subframe may become a PDCCH subframe.

In another example, a high priority UL signal includes a retransmitted UL signal. Namely, a UL subframe for transmission of a UL signal is classified as a key UL subframe.

According to an HARQ operation, a UE transmits a UL signal to a BS, and the BS feeds back ACK/NACK information indicating that the UL signal has been successfully received or reception of the UL signal has failed, to the UE. Here, the UE may receive NACK information from the BS or may fail to receive ACK/NACK information itself. In this case, the UE retransmits an already transmitted UL signal to the BS. The retransmitted UL signal is regarded as having relatively high importance.

In the half-duplex UE operation, when at least one UL subframe with respect to a plurality of serving cells serves to retransmit a UL signal, the union of DL subframe(s) conflicting with at least one UL subframe and/or special subframe(s) is not a PDCCH subframe. This is because, PRACH transmission is an operation controlled by a BS, having high priority. HARQ retransmission is controlled by each HARQ process, and a UL transmission timing determined for each HARQ process corresponds to a key UL subframe. Namely, a key UL subframe is determined by a UL transmission timing according to each HARQ process.

Besides a key UL subframe, an exceptional case in which a PDCCH subframe cannot be additionally defined is when a secondary serving cell is deactivated. Namely, all subframes during an interval in which a secondary serving cell is deactivated cannot become PDCCH subframes. This is because, a UE cannot monitor a PDCCH including DL resource allocation control information or UL resource allocation control information with respect to the deactivated secondary serving cell. Namely, the UE cannot monitor a PDCCH scrambled with a C-RNTI in a UE-specific search space set in a scheduling cell for the deactivated secondary serving cell.

On the basis of the definition of a PDCCH subframe considering a key UL subframe in this manner, the half-duplex UE operates as follows. In the present embodiment, a PDCCH subframe is an object to be monitored by the UE and an object of counting by a DRX-related timer. Namely, when a union of certain DL subframe(s) and/or special subframe(s) is determined as a PDCCH subframe, the UE performs monitoring on a PDCCH according to predetermined conditions and performs counting on the DRX-related timer.

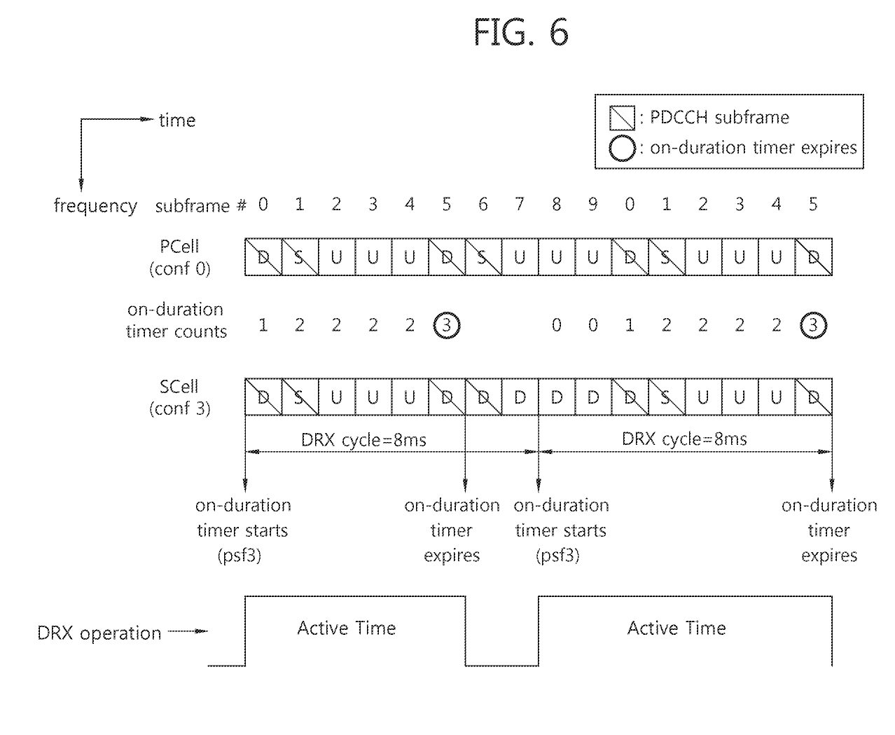

FIG. 6 is a view illustrating an operation of performing counting of an on-duration is timer by a UE according to an embodiment of the present invention.

Referring to FIG. 6, a primary serving cell Pcell and a secondary serving cell SCell are configured in a UE. The primary serving cell and the secondary serving cell are activated serving cells. In a system based on a TDD scheme, different TDD UL/DL configurations are allocated to the primary serving cell and the secondary serving cell. For example, the TDD UL/DL configuration #0 (conf 0) is allocated to the primary serving cell, and the TDD UL/DL configuration #3 (conf 3) is allocated to the secondary serving cell.

It is assumed that a period of a DRX cycle is 8 ms and a first expiration value regarding an on-duration timer is set to psf3. When the DRX cycle starts from subframe #0, the on-duration timer also starts together. As the on-duration timer starts, the UE enters an active time. During the active time, the UE monitors a PDCCH in PDCCH subframes. Here, the PDCCH subframes are based upon the premise that they are not a portion of a configured measurement gap.

Subframes #0 and #1 do not conflict and are DL subframes or special subframes with respect to all the serving cells. Thus, the subframes #0 and #1 are PDCCH frames. Thus, the UE increases a value of the duration time to 1 in the subframe #0 and increases it to 2 in the subframe #1.

Subframes #2, #3, and #4 are all UL subframes, which are not PDCCH subframes. Thus, the UE maintains the value of the on-duration timer as 2. Of course, even in this case, the active time continues.

Subframes #5 do not conflict and are DL subframes with respect to all the serving cells. Thus, the subframes #5 are PDCCH frames. The UE increases the value of the on-duration timer to 3. When the value of the on-duration timer is 3, which is equal to the first is expiration value psf3, so the UE expires the on-duration timer and terminates the active time.

However, since the period of the DRX cycle has not finished yet, the UE enters an inactive time in the other remaining subframes #6 and #7. Meanwhile, since 8 ms of the DRX cycle ends in the subframes #7, the first DRX cycle is finished.

A second DRX cycle starts from subframes #8. Here, similarly, the on-duration timer starts. Also, in this case, a first expiration value is psf3. As the on-duration timer starts, an active time also starts, and the UE performs PDCCH monitoring in each PDCCH subframe during the active time.

The subframes #8 and #9 conflict. If the UL subframes of the primary serving cell are key UL subframes, the subframes #8 and #9 are not PDCCH subframes. Thus, the UE cannot perform PDCCH monitoring and does not increase the on-duration timer. Meanwhile, the active time is maintained.

Subframes #0 and #1 of a subsequent radio frame are DL subframes or special subframes with respect to all the serving cells. Thus, the subframes #0 and #1 of the subsequent radio frame are PDCCH subframes. The UE increases the value of the on-duration timer up to 2.

Subframes #2, #3, and #4 of the subsequent radio frame are all UL subframes, not PDCCH subframes. Thus, the UE maintains the value of the on-duration timer as 2. Of course, the active time continues.

Subframe #5 of the subsequent radio frame do not conflict and are DL subframes with respect to all the serving cells. Thus, the subframes #5 of the subsequent radio frame are PDCCH subframes. The UE increases the value of the on-duration timer to 3.

When the value of the on-duration timer is 3, it is equal to the first expiration value psf3, so the UE terminates the on-duration timer and finishes the active time.

The embodiment of FIG. 6 is an example in which the UE counts the on-duration timer due to PDCCH subframes. However, such a technical concept may also be applied to a PDCCH subframe as a reference of an operation of counting a DRX inactivity timer and an operation of counting a DRX retransmission timer by the UE in the same manner.

Subframe Defined by the UE—Key UL Subframe is not Considered

In the half-duplex UE operation, a PDCCH subframe is defined as a union of DL subframes and special subframes of all serving cells. The PDCCH subframe may be defined irrespective of a key UL subframe. Namely, whether a subframe becomes a PDCCH subframe is not determined by a key UL subframe. Since an exception by a key UL subframe is not admitted, it is called a PDCCH subframe definition without considering a key UL subframe.

For example, in FIG. 4, it is assumed that three serving cells, i.e., the first secondary serving cell, the second secondary serving cell, and the third secondary serving cell, are configured in the half-duplex UE through carrier aggregation (CA). The subframes #4 are conflicting subframes, but the union of the DL subframe of the second secondary serving cell and the DL subframe of the third secondary serving cell may be defined as a PDCCH subframe. Even when the UL subframe of the first secondary serving cell is a key UL subframe, the subframes #4 are PDCCH subframes. Namely, according to the definition without considering a key UL subframe, the subframes #4 are PDCCH subframes.

In this manner, in the case in which an exception by a key UL subframe is not admitted in the definition of a PDCCH subframe, a problem that the UE cannot transmit a high priority UL signal by reason of the PDCCH subframe may arise. Thus, in the present embodiment, an exception is defined in the aspect of an operation of the half-duplex UE, rather than in the aspect of definition of a PDCCH subframe, to allow for transmission of a high priority UL signal. Here, the operation of the half-duplex UE includes, for example, a PDCCH monitoring operation and a counting operation of a DRX-related timer. In this manner, on the basis of the definition of a PDCCH subframe without considering a key UL subframe, the half-duplex UE operates as follows.

(1) For example, fundamentally, the UE performs PDCCH monitoring and counting of the DRX-related timer in a PDCCH subframe. However, in a case in which there is a key UL subframe (i.e., in a case in which a high priority UL signal is to be transmitted), the UE does not perform PDCCH monitoring nor counting of the DRX-related timer, exceptionally. Not performing PDCCH monitoring may refer to transmitting the high priority UL signal by the UE in spite of the PDCCH subframe. Also, not performing counting of the DRX-related timer may refer to not increasing the DRX-related timer in spite of a PDCCH subframe.

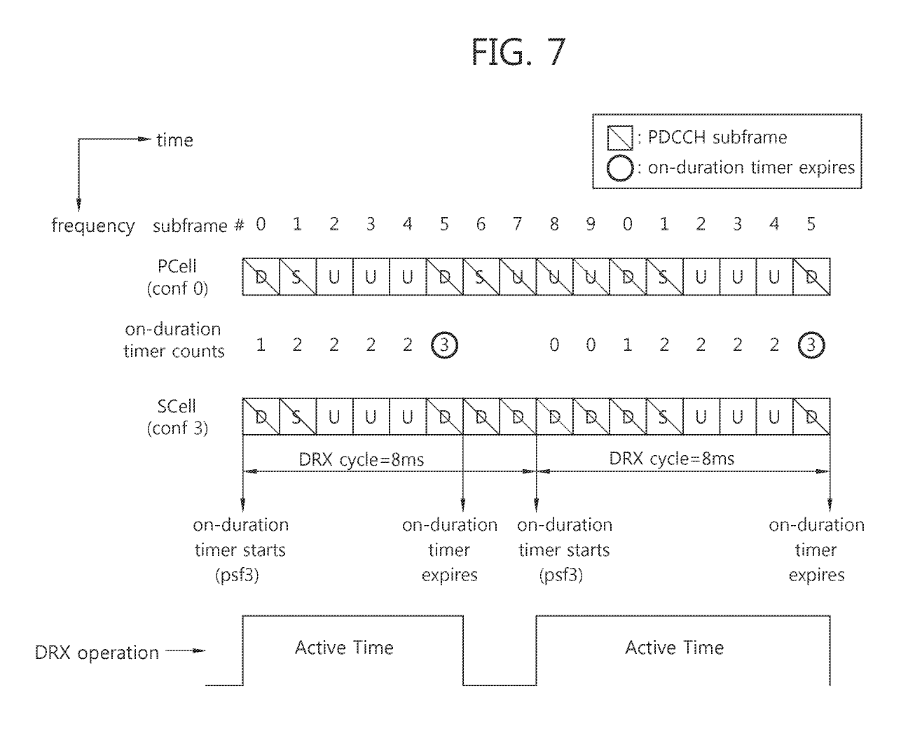

FIG. 7 is a view illustrating an operation of performing counting of an on-duration timer by a UE according to another embodiment of the present invention. This is an operation of the half-duplex UE according to the definition of a PDCCH subframe without considering a key UL subframe.

Referring to FIG. 7, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a first expiration value regarding an on-duration timer is set to psf3. This is the same as the conditions of FIG. 6.

Differences between the embodiment of FIG. 6 and that of FIG. 7 are PDCCH subframe numbers and a half-duplex UE operation in a PDCCH subframe.

According to the embodiment of FIG. 6, subframes #7, #8, and #9 are not PDCCH subframes. This is because, when there is a key UL subframe, the corresponding subframe is not defined as a PDCCH subframe. Since the subframes #7, #8, and #9 are not PDCCH subframes, the UE does not perform PDCCH monitoring and counting of the on-duration timer.

Meanwhile, according to the embodiment of FIG. 7, subframes #7, #8, and #9 are PDCCH subframes. This is because, although there is a key UL subframe, the corresponding subframe is defined as a PDCCH subframe. Although the subframes #7, #8, and #9 are classified as PDCCH subframes, the UE performs an exceptional operation from a vantage point of a UE operation. For example, when a key UL subframe exists in the primary serving cell, the UE does not count the on-duration timer nor perform PDCCH monitoring exceptionally.

The embodiment of FIG. 7 is an example in which the definition of a PDCCH subframe without consideration a key UL subframe is applied to the on-duration timer, a type of DRX-related timer. However, such a technical concept may also be applied to any other DRX-related timer, e.g., a DRX inactivity timer.

(2) In another example, in a PDCCH subframe, the UE performs PDCCH monitoring and counting of the DRX-related timer. However, in a case in which there is a key UL subframe (i.e., in a case in which a UL signal is to be transmitted), the UE does not perform PDCCH monitoring exceptionally. In other words, the case in which the UE performs PDCCH monitoring, is when a UL signal is not transmitted in a PDCCH subframe.

Not performing PDCCH monitoring may refer to transmitting the UL signal by the UE without receiving a PDCCH in spite of the PDCCH subframe. Meanwhile, although a key UL subframe exists, the UE still performs counting of the DRX-related timer in a PDCCH subframe.

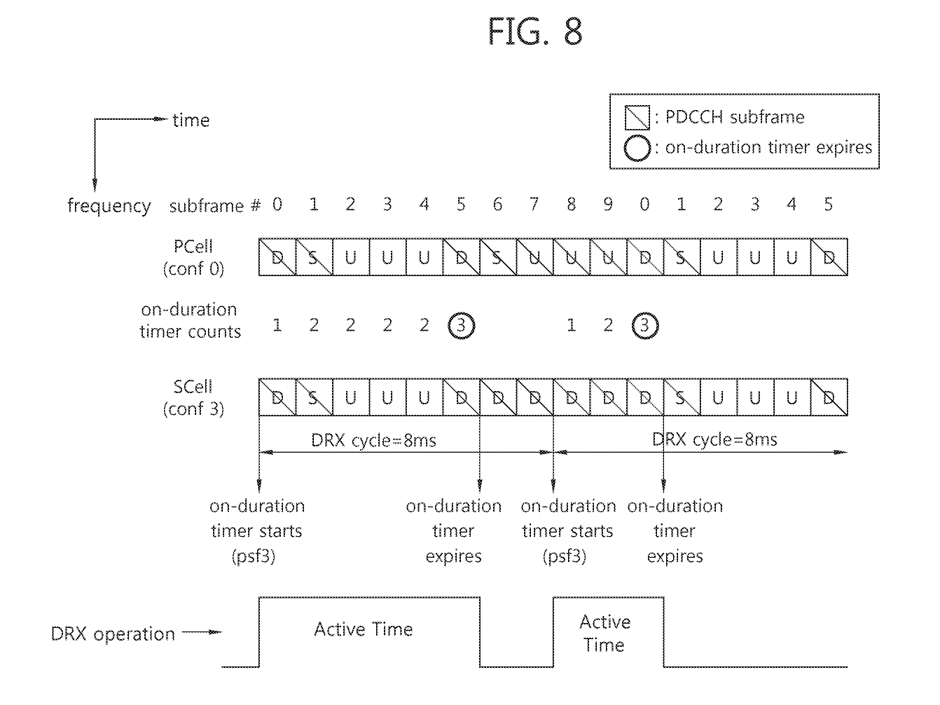

FIG. 8 is a view illustrating an operation of performing counting of an on-duration timer by a UE according to another embodiment of the present invention. In FIG. 8, an operation of the half-duplex UE according to the definition of a PDCCH subframe without considering a key UL subframe is illustrated.

Referring to FIG. 8, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a first expiration value regarding an on-duration timer is set to psf3. This is the same as the conditions of FIG. 6.

Differences between the embodiment of FIG. 6 and that of FIG. 8 are PDCCH subframe numbers and a half-duplex UE operation in a PDCCH subframe.

According to the embodiment of FIG. 6, subframes #7, #8, and #9 are not PDCCH subframes. This is because, when there is a key UL subframe, the corresponding subframe is not defined as a PDCCH subframe. Since the subframes #7, #8, and #9 are not PDCCH subframes, the UE does not perform PDCCH monitoring and counting of the on-duration timer.

Meanwhile, according to the embodiment of FIG. 8, subframes #7, #8, and #9 are PDCCH subframes. This is because, although there is a key UL subframe, the corresponding subframe is defined as a PDCCH subframe. Thus, the UE counts the on-duration timer. For example, the UE increases the on-duration timer to 1 in subframes #8 from which a next DRX cycle starts, increases the on-duration timer to 2 in subframes #9, and increases the on-duration timer to 3 in subframes #0 of a subsequent radio frame. At this time, the on-duration timer expires.

Meanwhile, the UE does not perform PDCCH monitoring, exceptionally. Namely, although the subframes #7, #8, and #9 are classified as PDCCH subframes, the UE performs an exceptional operation from a vantage point of PDCCH monitoring. For example, when a key UL subframe exists in a serving cell, the UE does not perform PDCCH monitoring, exceptionally. In other words, in order for the UE to perform PDCCH monitoring, a key UL subframe should not exist in a serving cell (i.e., there is no uplink signal transmission).

The embodiment of FIG. 8 is an example in which the definition of a PDCCH subframe without consideration a key UL subframe is applied to the on-duration timer, a type of DRX-related timer. However, such a technical concept may also be applied to any other DRX-related timer, e.g., a DRX inactivity timer.

A DRX retransmission timer relates to an HARQ operation. An HARQ operation is not simply limited to a process of monitoring a PDCCH. For example, in order to perform retransmission of a DL signal, the UE should monitor a PDCCH and subsequently receive even a PDSCH indicated by the PDCCH. A problem is, in a case in which so-called cross-carrier scheduling according to which a serving cell in which signal retransmission takes place and a serving cell that schedules the signal retransmission are separated is supported, a PDCCH and a PDSCH are transmitted on different serving cells, so counting conditions of the DRX retransmission timer may be changed. This is because, whether to perform HARQ retransmission and a managing operation are independently conducted in each serving cell.

Hereinafter, a counting scheme of the DRX retransmission timer and a PDCCH monitoring scheme according to an embodiment of the present invention resulting from a difference between a full-duplex UE operation and a half-duplex UE operation will be described. Also, an operation scheme of the DRX retransmission timer and a PDCCH monitoring scheme is resulting from a difference between cross-carrier scheduling and self-scheduling will be described.

Operation Scheme of Retransmission Timer

(1) Operation of DRX Retransmission Timer in Half-Duplex UE Operation

A) For example, the DRX retransmission timer may operate according to the definition of a PDCCH subframe considering a key UL subframe.

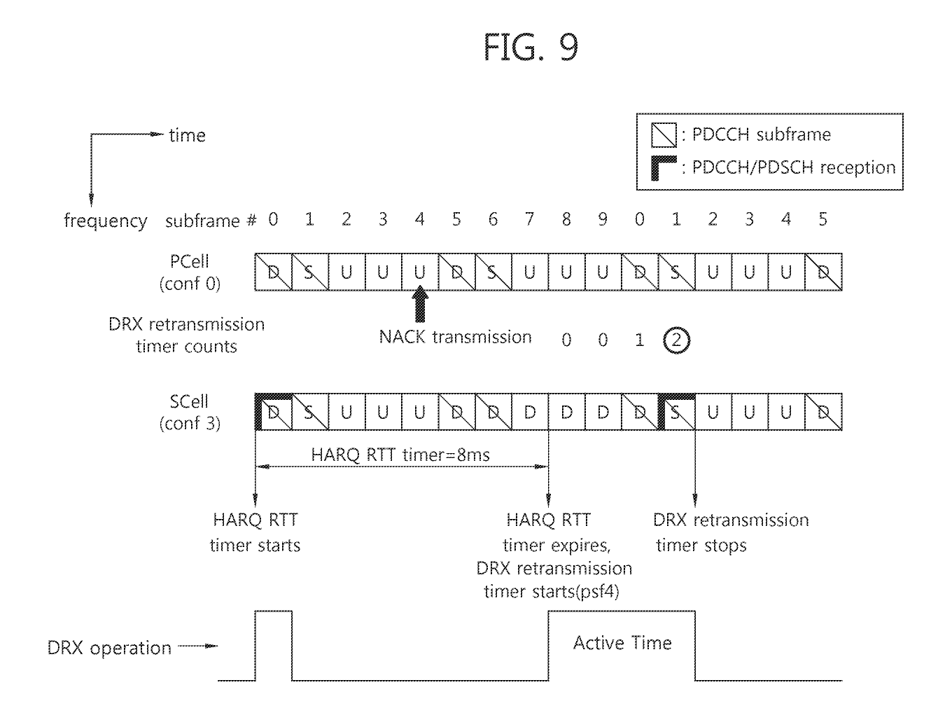

FIG. 9 is a view illustrating an operation of performing counting of a DRX retransmission timer by a UE according to an embodiment of the present invention, which is based on self-scheduling.

Referring to FIG. 9, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a third expiration value regarding the DRX retransmission timer is set to psf5.

The UE receives a PDCCH and a PDSCH in a secondary serving cell of subframes #0. Here, an HARQ process No. (#P) is 1. The subframes #0 are all DL subframes with respect to the primary serving cell and the secondary serving cell, which are, thus, PDCCH subframes. As the UE receives the PDCCH and the PDSCH in the secondary serving cell, an HARQ RTT timer of the UE starts. In detail, the HARQ RTT timer may start according to a following procedure. The UE checks whether the PDCCH received through the scheduling cell indicates the presence of downlink data transmission. This is the same in a case in which the UE knows the presence of DL data transmission in advance through semi-persistent scheduling (SPS). Also, the UE checks whether a carrier indication field (CIF) exists in the PDCCH. When is the CIF exists, the UE checks whether for which serving cell, the PDCCH is, on the basis of the CIF. Thereafter, the UE starts the HARQ RTT timer related to a particular HARQ process according to HARQ entity information in the PDCCH. In the case of the SPS, the UE starts the HARQ RTT timer related to a particular HARQ process according to pre-set HARQ entity information.

The HARQ RTT timer specifies a minimum number of subframes prior to DL retransmission expected by the UE. For example, in case of an FDD system, the HARQ RTT timer is set with eight subframes. Meanwhile, in case of a TDD system, the HARQ RTT timer is set with (k+4) number of subframes, and here, k is defined by an interval between downlink transmission and HARQ feedback transmission. The k value is defined as shown in Table 3.

TABLE 3

| UL/DL | | | | | | | | | | |
|---|---|---|---|---|---|---|---|---|---|---|
| configura- | Subframe n | | | | | | | | | |
| tion | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, | — | — |
| | | | | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

For example, in a TDD UL/DL configuration ‘0’, ACK/NACK information with respect to DL data received by the UE in subframe #0 is transmitted in a subframe #4. Here, according to Table 3, k=4, so the HARQ RTT timer with respect to the DL data received in the subframe #0 is 8.

The HARQ RTT timer is defined in every DL HARQ process. While the HARQ RTT timer is running, the UE determines that there will be no retransmission of DL data with respect to the corresponding HARQ process. Thus, the UE does not perform a reception operation with respect to the corresponding HARQ process. For example, if the UE does not perform any reception operation of DL data other than the HARQ process and the corresponding subframe is not included in an active time, the UE may not need to perform PDCCH monitoring.

If decoding of the PDSCH in the subframe #0 fails, the UE transmits NACK transmission through the primary serving cell in a subframe #4 after four subframes to the BS. The HARQ RTT timer expires in subframe #7.

Here, as for determination of the conditions for the DRX retransmission to start, a UL subframe is configured in the primary serving cell and a DL subframe is configured in the secondary serving cell in subframe #8. Namely, the subframe #8 is a conflicting subframe: i) the HARQ RTT timer expires, ii) data in the HARQ buffer is decoded, and when the decoding results is failure, the DRX retransmission timer start. From this moment, an active time starts and the UE performs PDCCH monitoring. The conditions in which the DRX retransmission timer starts are the same all the time according to an embodiment of the present invention.

As for determination of conditions under which the DRX retransmission timer increases, Subframes #8 configured as key UL subframes are not PDCCH subframes. This is is the same with the subframes #9. Namely, the conditions for increasing the DRX retransmission timer are not satisfied in the subframes #8 and #9. Thus, the UE maintains the value of DRX retransmission timer as 0, rather than increasing it.

Subframes #0 of a subsequent radio frame do not conflict and are DL subframes with respect to all the serving cells. Thus, the subframes #0 are PDCCH subframes. The UE increases the value of the DRX retransmission timer to 1. Subframe #1 of the subsequent radio frame do not conflict and are special subframes with respect to all the serving cells. Thus, the subframes #1 of the subsequent radio frame are PDCCH subframes. The UE increases the value of the DRX retransmission timer to 2.

In this case, however, when a PDCCH transmitted according to retransmission with respect to the corresponding HARQ process with respect to the corresponding serving cell is received, the UE stops the DRX retransmission timer. Accordingly, the active time is terminated. Conditions for terminating the DRX retransmission timer are the same all the time in the present invention.

B) In another example, the DRX retransmission timer may operate according to a definition of a PDCCH subframe without considering a key UL subframe. This is an operation in which the UE does not perform PDCCH monitoring in a PDCCH subframe exceptionally. However, counting of the DRX retransmission timer is performed.

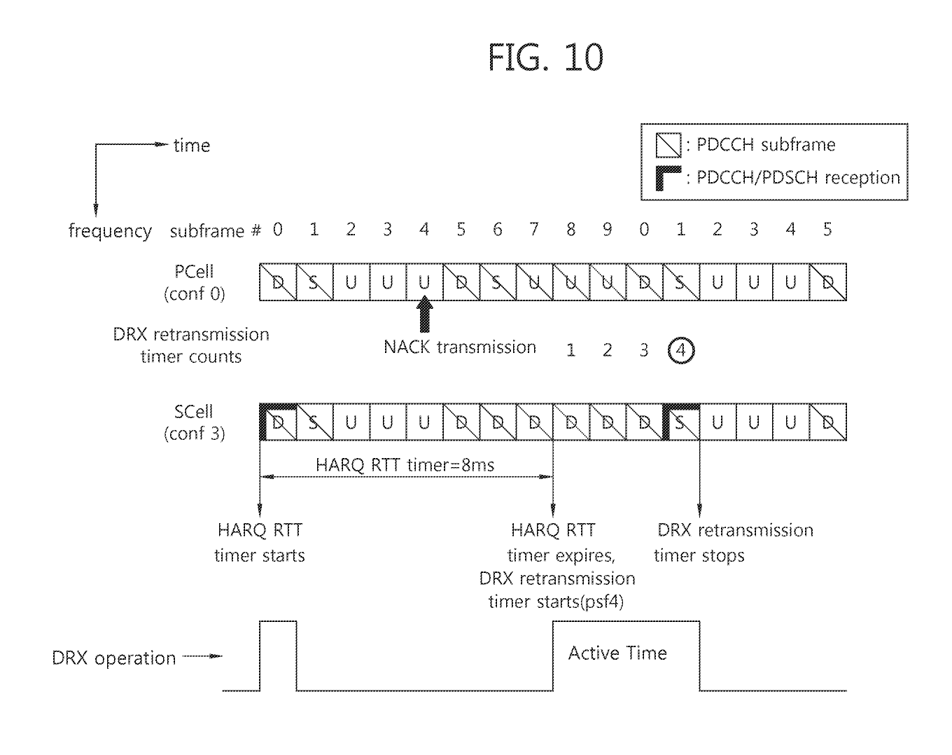

FIG. 10 is a view illustrating an operation of performing counting of a DRX retransmission timer by a UE according to another embodiment of the present invention. The operation is based on self-scheduling.

Referring to FIG. 10, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a third expiration value regarding the DRX retransmission timer is set to psf5. This is the same as the conditions of FIG. 9.

Differences between the embodiment of FIG. 9 and that of FIG. 10 are PDCCH subframe numbers and a half-duplex UE operation in a PDCCH subframe.

According to the embodiment of FIG. 9, subframes #8 and #9 are not PDCCH subframes. This is because, when there is a key UL subframe, the corresponding subframe is not defined as a PDCCH subframe. Since the subframes #8 and #9 are not PDCCH subframes, the UE does not perform PDCCH monitoring and counting of the on-duration timer.

Meanwhile, according to the embodiment of FIG. 10, subframes #8 and #9 are PDCCH subframes. This is because, although there is a key UL subframe, the corresponding subframe is defined as a PDCCH subframe. Although the subframes #8 and #9 are classified as PDCCH subframes, the UE performs an exceptional operation from a vantage point of PDCCH monitoring. For example, when a key UL subframe exists in the primary serving cell, the UE counts the DRX retransmission timer but does not perform PDCCH monitoring.

Since the subframes #8 and #9 and even the subframes #0 and #1 of the subsequent radio frame are all PDCCH subframes, the UE increases the DRX retransmission timer by 1 each time in each of the four subframes. Accordingly, the DRX retransmission timer in the subframes #1 of a subsequent radio frame is 4. However, the UE does not perform PDCCH monitoring in subframes #8 and #9 exceptionally.

C) In another example, the DRX retransmission timer may operate according to a definition of a PDCCH subframe without considering a key UL subframe. This is an operation in is which the UE does not perform PDCCH monitoring and counting of the DRX retransmission timer in a PDCCH subframe exceptionally.

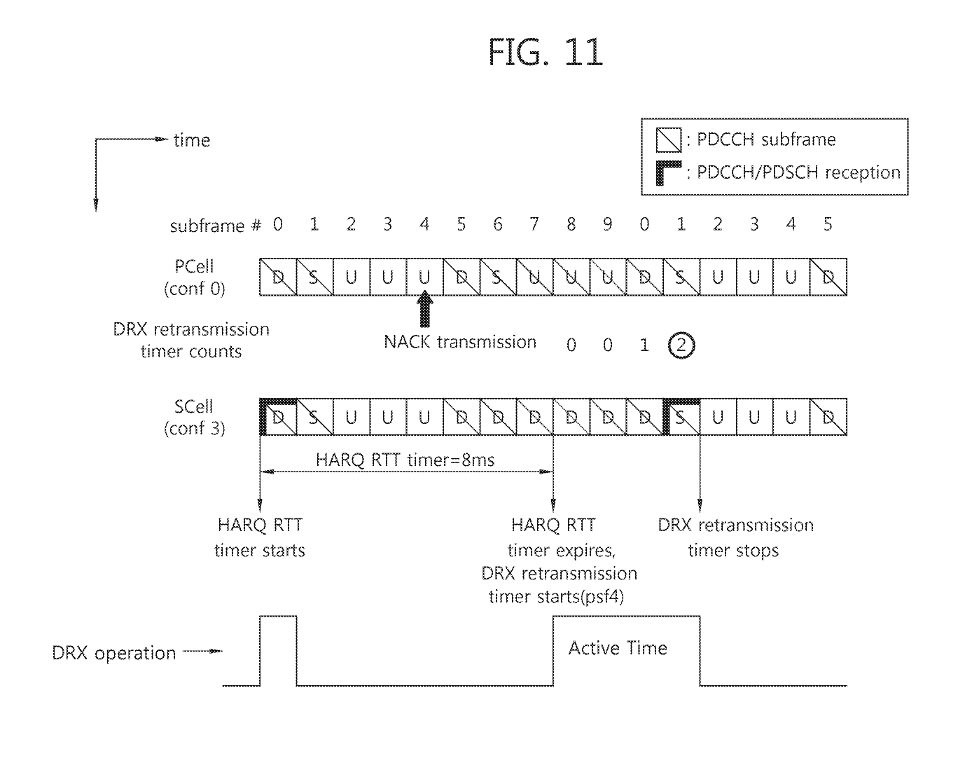

FIG. 11 is a view illustrating an operation of performing counting of a DRX retransmission timer by a UE according to another embodiment of the present invention. The operation is based on self-scheduling.

Referring to FIG. 11, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a third expiration value regarding the DRX retransmission timer is set to psf5. This is the same as the conditions of FIG. 9.

Differences between the embodiment of FIG. 9 and that of FIG. 11 are PDCCH subframe numbers and a half-duplex UE operation in a PDCCH subframe.

According to the embodiment of FIG. 9, subframes #8 and #9 are not PDCCH subframes. This is because, when there is a key UL subframe, the corresponding subframe is not defined as a PDCCH subframe. Since the subframes #8 and #9 are not PDCCH subframes, the UE does not perform PDCCH monitoring and counting of the on-duration timer.

Meanwhile, according to the embodiment of FIG. 11, subframes #8 and #9 are PDCCH subframes. This is because, although there is a key UL subframe, the corresponding subframe is defined as a PDCCH subframe. Although the subframes #8 and #9 are classified as PDCCH subframes, the UE performs an exceptional operation from a vantage point of PDCCH monitoring and DRX retransmission counting operation. For example, when a key UL subframe exists in the primary serving cell, the UE does not perform counting of the DRX retransmission is timer nor PDCCH monitoring.

Here, the subframes #8 and #9 and even the subframes #0 and #1 of the subsequent radio frame are all PDCCH subframes. However, since subframes #8 and #9 are key UL subframes, the UE does not perform counting of the DRX retransmission timer nor PDCCH monitoring. Thus, the DRX retransmission timer is maintained as 0. Meanwhile, subframes #0 and #1 of the subsequent radio frame are not key UL subframes, so the UE performs counting of the DRX retransmission timer and PDCCH monitoring.

Accordingly, the DRX retransmission timer in the subframes #1 is 2.

D) In another example, the DRX retransmission timer may operate in consideration of directionality of resource allocation, or the like, in self-scheduling.

In the case of the half-duplex UE, in a case in which i) the HARQ RTT timer expires, ii) a DL subframe or a special subframe is configured in a serving cell in which HARQ retransmission takes place, and iii) a reference cell for determining a DL/UL direction does not exists and a UL subframe is not configured through a different reference such as resource allocation directionality, or the like, the DRX retransmission timer starts. After the DRX retransmission timer starts, when the conditions ii) and iii) are met, the UE increases a value of the DRX retransmission timer by 1. This resultantly requires that PDCCH subframes be configured in all serving cells configured in the UE on the basis of a current subframe.

Meanwhile, in the multiple component carrier system, the DRX retransmission timer is stopped in a case in which, i) while the DRX retransmission timer is running, ii) the UE successfully decodes a PDCCH in a scheduling cell with respect to a serving cell in which HARQ transmission takes place, and the PDCCH indicates information regarding DL resource allocation and includes information regarding a process during which the HARQ retransmission is takes place

E) In another example, in cross-carrier scheduling, the DRX retransmission timer may operate in consideration of a scheduling cell (e.g., a primary serving cell).

The UE counts the DRX retransmission timer on the basis of the following conditions: i) a DL subframe or a special subframe should be configured in a scheduling cell with respect to a secondary serving cell in which HARQ retransmission takes place, and ii) a DL subframe is configured in a secondary serving cell in which HARQ retransmission takes place. As for conditions for changing a direction of a subframe, the foregoing references may be applied. When a PDCCH indicating DL resource allocation related to an HARQ process for which the DRX retransmission timer operates is received, the UE may stop the DRX retransmission timer. Accordingly, the active time is terminated.

F) In another example, in cross-carrier scheduling, the DRX retransmission timer may operate in consideration of a scheduling cell, a high priority uplink signal, and the like.

The UE starts the DRX retransmission timer when the following conditions are all met: i) the HARQ RTT timer should expire, and ii) decoding of data in a soft buffer related to the corresponding HARQ process should fail.

Also, the UE counts the DRX retransmission timer on the basis of the following conditions: i) a DL subframe or a special subframe should be configured in a scheduling cell with respect to a serving cell in which HARQ retransmission takes place, ii) a DL subframe or a special subframe should be configured in a serving cell in which HARQ retransmission takes place, iii) a UL subframe should not be configured in a reference cell that determines DL/UL priority; iv) there shouldn't be transmission of a high priority UL signal, and v) UL retransmission should not take place in every serving cell.

After the DRX retransmission timer starts, when the conditions ii), iii), iv), and v) are met, the UE increases a value of the DRX retransmission timer by 1. This resultantly requires that a direction of the half-duplex UE be downlink, a current subframe be a PDCCH subframe, and a DL subframe or a special subframe be configured in a scheduling cell with respect to a serving cell in which HARQ retransmission takes place. Here, the entirety or some of the conditions iii), iv), and v) may be excluded in defining a PDCCH subframe.

(2) Operation of DRX Retransmission Timer in Full-Duplex UE Operation

In case of a full-duplex UE, the UE may simultaneously perform UL transmission and DL reception. Thus, a subframe conflict does not occur. In a case in which at least even one DL subframe is configured in a plurality of serving cells, the corresponding subframe is defined as a PDCCH subframe. The UE performs PDCCH monitoring in every PDCCH subframe. However, conditions for counting the DRX retransmission timer should be re-defined in relation to an HARQ retransmission operation, and a timer value should not be unconditionally increased for a PDCCH subframe.

A) In Case of Cross-Carrier Scheduling

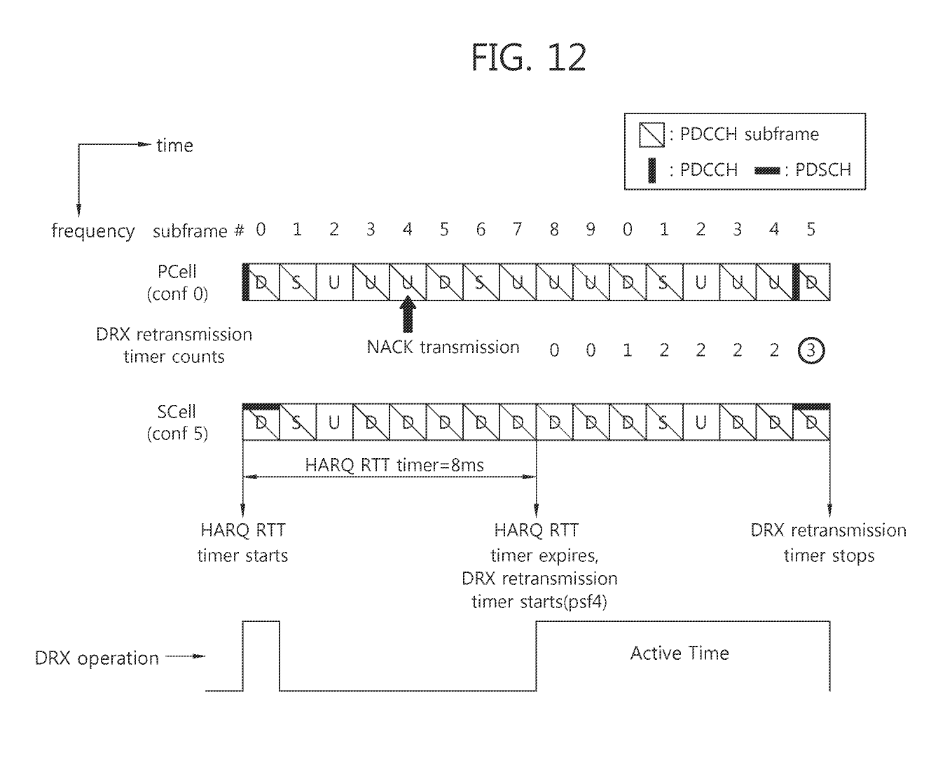

FIG. 12 is a view illustrating an operation of performing counting of a DRX retransmission timer by a UE according to another embodiment of the present invention. In this method, a subframe in which a PDCCH is not received in a scheduling cell is excluded in counting the DRX retransmission timer.

Referring to FIG. 12, a primary serving cell Pcell and a secondary serving cell SCell are configured in a UE. The TDD UL/DL configuration #0 (conf 0) is allocated to the primary serving cell, and the TDD UL/DL configuration #5 (conf 5) is allocated to the secondary serving cell. It is assumed that a period of a DRX cycle is 8 ms and a third expiration value is regarding the DRX retransmission timer is set to psf5. PDCCH subframes are subframes #0, #1, #3, #4, #5, #6, #7, #8, and #9 and subframes #0, #1, #3, #4, and #5 in a subsequent radio frame.

The primary serving cell is a scheduling cell with respect to the secondary serving cell, and the UE receives a PDCCH for the secondary serving cell on the primary serving cell of the subframe #0. The UE checks whether the PDCCH received through the primary serving cell indicates the presence of DL data transmission. The UE checks whether there is a carrier indicator field (CIF) in the PDCCH. When the CIF exists, the UE ascertains that the PDCCH serves for the secondary serving cell on the basis of the CIF. Thereafter, the UE starts the HART RTT timer related to a specific HARQ process according to HARQ entity information in the PDCCH.

The UE receives a PDSCH on the secondary serving cell of a subframe #0. Here, an HARQ process No. is P#1. If decoding of the PDSCH in the subframe #0 fails, the UE transmits NACK information through the primary serving cell in the subframe #4 after four subframes to a BS. The HARQ RTT timer expires in subframe #7.

Here, the UE starts the DRX retransmission timer when the following conditions are met: i) the HARQ RTT timer should expire, and ii) decoding of data in a soft buffer related to the corresponding HARQ process should fail.

Meanwhile, in order to increase a value of the DRX retransmission timer, a DL subframe or a special subframe is required to be configured in a scheduling cell with respect to a serving cell in which HARQ retransmission takes place. In other words, if a DL subframe is not configured or a special subframe does not exist in the scheduling cell of the serving cell in which HARQ retransmission takes place, a value of the DRX retransmission timer in the immediately previous subframe is maintained as is. This is because counting the timer on the basis of a PDCCH subframe limited to a serving cell in which HARQ retransmission is performed corresponds with the designing intentions of the DRX retransmission timer.

Here, the subframe #8 is a PDCCH subframe with respect to the secondary serving cell in which HARQ retransmission takes place. Since conditions for starting the DRX retransmission timer are met, the UE starts the DRX retransmission timer. And, the UE enters an active time. Meanwhile, the subframe #8 is not a PDCCH subframe with respect to the primary serving cell, a scheduling cell, so the UE does not increase the DRX retransmission timer. Namely, a value of the DRX retransmission timer is 0. This is the same with the subframe #9.

The subframe #0 of the subsequent radio frame is a PDCCH subframe with respect to the primary serving cell as a scheduling cell. Thus, the conditions for counting the DRX retransmission timer are met. The UE increases the DRX retransmission timer to 1. Also, the conditions for counting the DRX retransmission timer are met in the subframe #1 of the subsequent radio frame. Thus, the UE increases the DRX retransmission timer to 2 in the subframe #1 of the subsequent radio frame.

Thereafter, the conditions for counting the DRX retransmission timer are not met in all the subframes #2, #3, and #4 of the subsequent radio frame, so the UE maintains the DRX retransmission timer as 2, and increases the value of the DRX retransmission timer to 3 in the subframe #5.

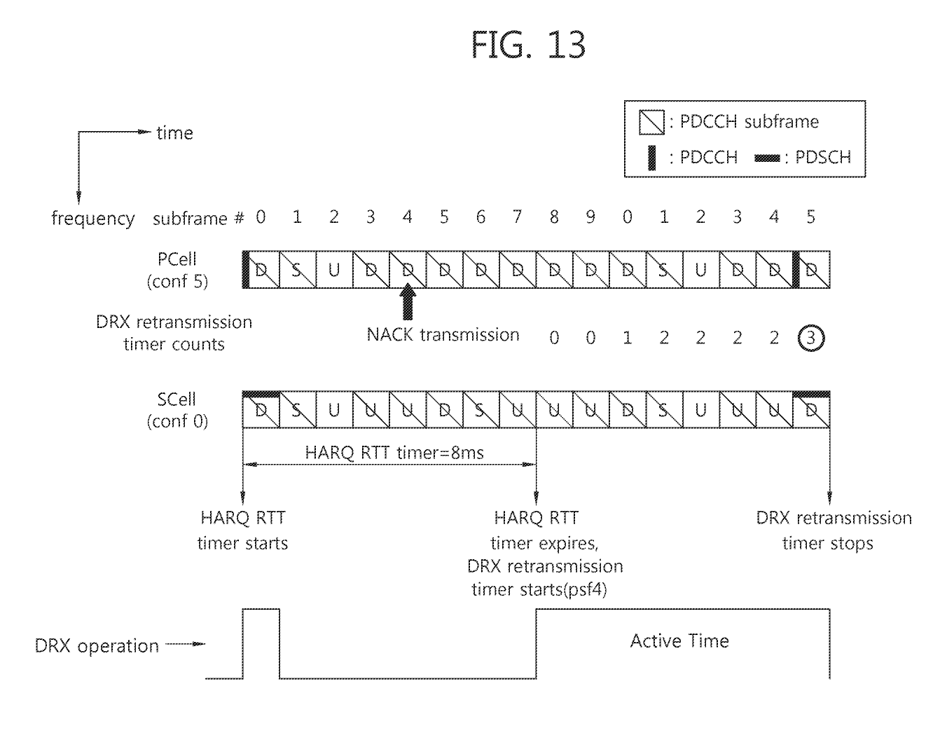

FIG. 13 is a view illustrating an operation of performing counting of a DRX retransmission timer by a UE according to another embodiment of the present invention. In this method, a subframe in which a PDSCH is not received in a serving cell in which HARQ retransmission takes place is excluded in counting the DRX retransmission timer.

Referring to FIG. 13, a primary serving cell Pcell and a secondary serving cell SCell are configured in a UE. The TDD UL/DL configuration #5 (conf 5) is allocated to the primary serving cell, and the TDD UL/DL configuration #0 (conf 0) is allocated to the secondary serving cell. It is assumed that a period of a DRX cycle is 8 ms and a third expiration value regarding the DRX retransmission timer is set to psf5. PDCCH subframes are subframes #0, #1, #3, #4, #5, #6, #7, #8, and #9 and subframes #0, #1, #3, #4, and #5 in a subsequent radio frame.

The primary serving cell is a scheduling cell with respect to the secondary serving cell, and the UE receives a PDCCH for the secondary serving cell on the primary serving cell of the subframe #0. The UE checks whether the PDCCH received through the primary serving cell indicates the presence of DL data transmission. The UE checks whether there is a carrier indicator field (CIF) in the PDCCH. When the CIF exists, the UE ascertains that the PDCCH serves for the secondary serving cell on the basis of the CIF. Thereafter, the UE starts the HARQ RTT timer related to a specific HARQ process according to HARQ entity information in the PDCCH.

The UE receives a PDSCH on the secondary serving cell of a subframe #0. Here, an HARQ process No. is 1 (P#1). If decoding of the PDSCH in the subframe #0 fails, the UE transmits NACK information through the primary serving cell in the subframe #4 after four subframes to a BS. The HARQ RTT timer expires in subframe #7.

Here, the DRX retransmission timer starts when the following conditions are met: i) the HARQ RTT timer should expire, and ii) decoding of data in a soft buffer related to the corresponding HARQ process should fail.

Meanwhile, in order to increase a value of the DRX retransmission timer, a DL subframe or a special subframe is required to be configured in a serving cell in which HARQ is retransmission takes place. In other words, if a DL subframe is not configured or a special subframe does not exist in the serving cell in which HARQ retransmission takes place, a value of the DRX retransmission timer in the immediately previous subframe is maintained as is. This is because counting the timer on the basis of whether a PDSCH is transmittable in the serving cell in which HARQ retransmission is performed corresponds with the designing intentions of the DRX retransmission timer.

Here, the subframe #8 is a PDCCH subframe. Thus, since conditions for starting the DRX retransmission timer are met, the UE starts the DRX retransmission timer. And, the UE enters an active time. Meanwhile, the subframe #8 is not DL subframe or a special subframe with respect to the secondary serving cell in which HARQ retransmission takes place, so the UE does not increase the DRX retransmission timer. Namely, a value of the DRX retransmission timer is 0. This is the same with the subframe #9.

The subframe #0 of the subsequent radio frame is a DL subframe with respect to the secondary serving cell. Thus, the conditions for counting the DRX retransmission timer are met. The UE increases the DRX retransmission timer to 1. Also, the conditions for counting the DRX retransmission timer are met in the subframe #1 of the subsequent radio frame. Thus, the UE increases the DRX retransmission timer to 2 in the subframe #1 of the subsequent radio frame.

Thereafter, the conditions for counting the DRX retransmission timer are not met in all the subframes #2, #3, and #4 in the subsequent radio frame, so the UE maintains the DRX retransmission timer as 2, and increases the value of the DRX retransmission timer to 3 in the subframe #5.

B) in Case of Self-Scheduling

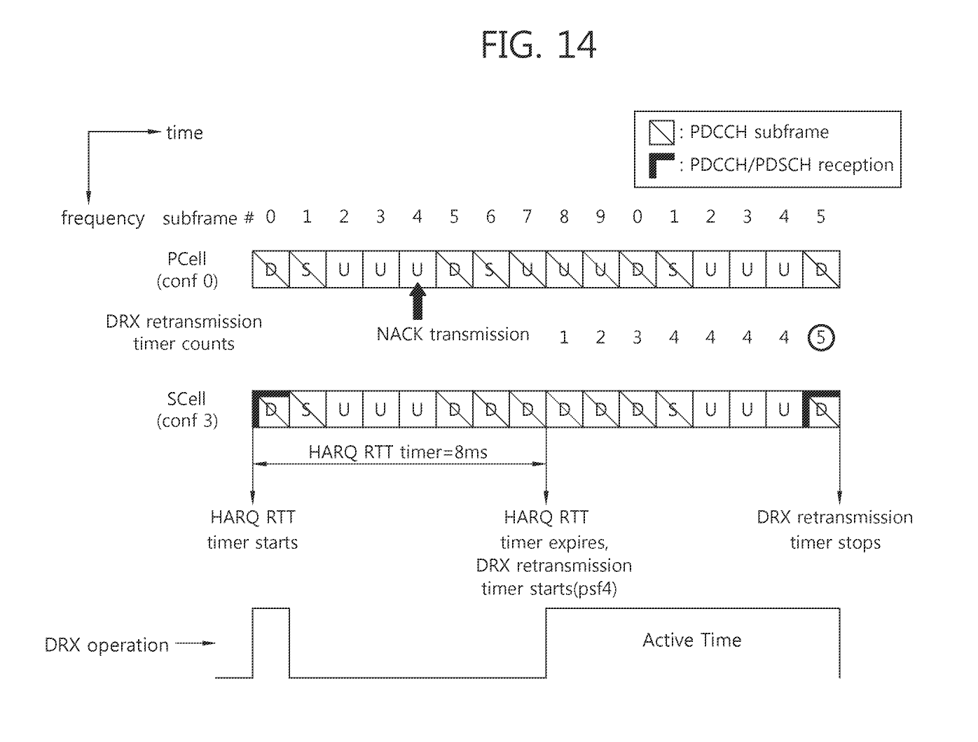

FIG. 14 is a view illustrating an operation of performing counting of a DRX retransmission timer by a UE according to another embodiment of the present invention.

Referring to FIG. 14, a primary serving cell Pcell and a secondary serving cell SCell are configured in a UE. The TDD UL/DL configuration #0 (conf 0) is allocated to the primary serving cell, and the TDD UL/DL configuration #3 (conf 3) is allocated to the secondary serving cell. It is assumed that a period of a DRX cycle is 8 ms and a third expiration value regarding the DRX retransmission timer is set to psf5. PDCCH subframes are subframes #0, #1, #5, #6, #7, #8, and #9 and subframes #0, #1, and #5 in a subsequent radio frame.

Through self-scheduling, the UE receives a PDCCH and a PDSCH on the secondary serving cell of the subframe #0. The UE starts the HARQ RTT timer related to a specific HARQ process according to HARQ entity information in the PDCCH. Here, the HARQ process No. is 1 (P#1).

If decoding of the PDSCH in the subframe #0 fails, the UE transmits NACK information in the subframe #4 after four subframes through the primary serving cell to the BS. The HARQ RTT timer expires in the subframe #7.

Here, in a case in which a corresponding subframe is a PDCCH subframe and a DL subframe or a special subframe is configured in the serving cell in which HARQ retransmission takes place, the DRX retransmission timer performs counting.

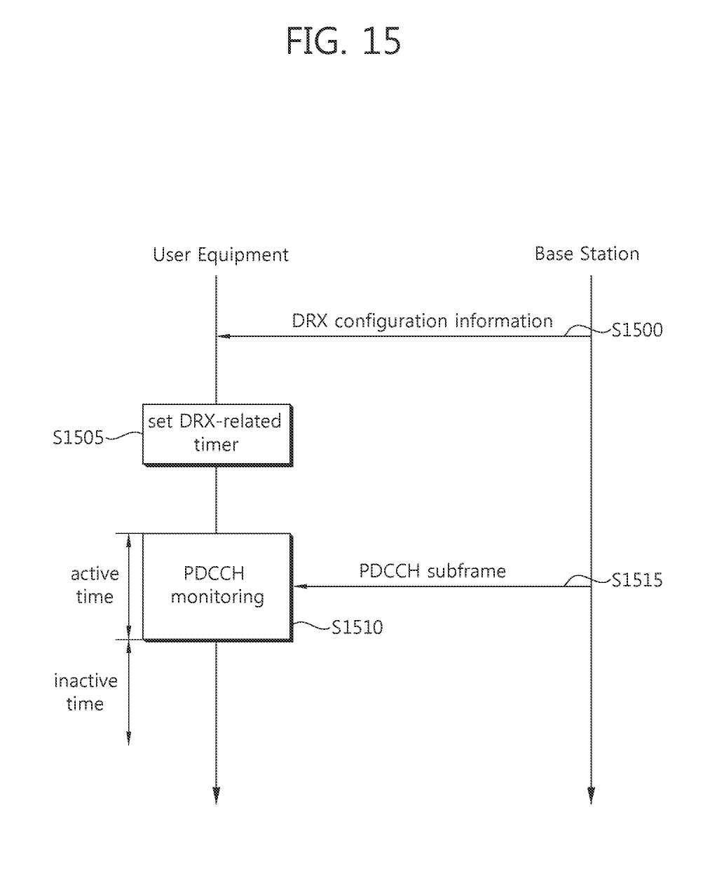

FIG. 15 is a signaling flow chart between a UE and a base station (BS) according to an embodiment of the present invention.

Referring to FIG. 15, the BS transmits DRX configuration information to the UE (S 1500). The DRX configuration information is a set of parameters required for a DRX operation, which specifies a value of an on-duration timer, a value of a DRX inactivity timer, and is a value of a DRX retransmission timer. Meanwhile, the DRX configuration information may be included in a MAC-MainConfig message, an RRC message, used for specifying major components of a MAC layer for a signaling radio bearer (SRB) and a data radio bearer (DRB) and received. The DRX configuration information may be configured as shown Table 4 below, for example.

TABLE 4

| DRX-Config ::= | CHOICE { |
|---|---|
| release | NULL, |
| setup | SEQUENCE { |
| onDurationTimer | ENUMERATED { |
| psf1, psf2, psf3, psf4, psf5, psf6, | |
| psf8, psf10, psf20, psf30, psf40, | |
| psf50, psf60, psf80, psf100, | |
| psf200}, | |
| drx-InactivityTimer | ENUMERATED { |
| psf1, psf2, psf3, psf4, psf5, psf6, | |
| psf8, psf10, psf20, psf30, psf40, | |
| psf50, psf60, psf80, psf100, | |
| psf200, psf300, psf500, psf750, | |
| psf1280, psf1920, psf2560, psf0-v1020, | |
| spare9, spare8, spare7, spare6, | |
| spare5, spare4, spare3, spare2, | |
| spare1}, | |
| drx-RetransmissionTimer | ENUMERATED { |
| psf1, psf2, psf4, psf6, psf8, psf16, | |
| psf24, psf33}, | |
| } OPTIONAL | -- Need OR |
| } | |

Referring to Table. 4, the DRX configuration information includes an on DurationTimer field limiting a value of an on-duration timer, a drx-InactivityTimer field indicating a value of a DRX inactivity timer, and a drx-RetransmissionTimer indicating a value of a DRX retransmission timer. The on DurationTimer field may be set with any one of values {psf1, psf2, psf3, . . . psf200} in which psf signifies a PDCCH subframe and the number behind psf indicates the number of PDCCH subframes. Namely, psf indicates an expiration value of a timer with the number of PDCCH subframes. For example, in case of on DurationTimer field=psf1, the on-duration timer is running up to accumulatively one PDCCH subframe including a subframe in which a DRX cycle started, and subsequently expires. Or, in case of on DurationTimer field=psf4, the on-duration timer is running up to accumulatively four PDCCH subframes from the start of the DRX cycle, and subsequently expires.

The drx-InactivityTimer field may be set to any one of values {psf1, psf2, psf3, . . . psf2560}. For example, in case of drx-InactivityTimer field=psf3, the DRX inactivity timer is running up to accumulatively three PDCCH subframes including a subframe at a point in time at which the DRX inactivity timer starts to be driven, and subsequently expires. The drx-RetransmissionTimer field is set to any one of values {psf1, psf2, psf4, . . . psf33}. For example, in case of drx-RetransmissionTimer field=psf4, the DRX retransmission timer is running up to accumulatively four PDCCH subframes including a subframe at a point in time at which the DRX retransmission timer starts to be driven, and subsequently expires.

However, in an exceptional case, in spite of a PDCCH subframe, the UE may not increase the value of the DRX-related timer.

The UE sets the DRX-related timer on the basis of DRX configuration information (S 1505). The DRX-related timer includes an on-duration timer, a DRX inactivity timer, and a DRX retransmission timer. For example, the UE may set a first expiration value of the on-duration timer to psf3, a second expiration value of the DRX inactivity timer to psf2, and is a third expiration value of the DRX retransmission timer to psf4.

For example, psf may be defined as a DL subframe or a special subframe configured in a scheduling cell with respect to a serving cell in which HARQ retransmission takes place. Thus, psf used in the DRX retransmission timer may be construed as having a different meaning from that of psf used in the on-duration timer or pas used in the DRX inactivity timer. Namely, although they are psf, field values used in the DRX retransmission timer may be applied with a different operation.

In another example, start and a count unit of the DRX retransmission timer may be defined in a new form such as dpsf (downlink PDCCH subframe).

The UE may progress an active time in a DRX cycle on the basis of a start condition of each timer and a counting (or increasing) condition of a timer value, a stop condition, and an expiration condition thereof, and may monitor a PDCCH within the active time (S1510).

During the active time, a BS may transmit a PDCCH subframe required for the UE (S 1515).

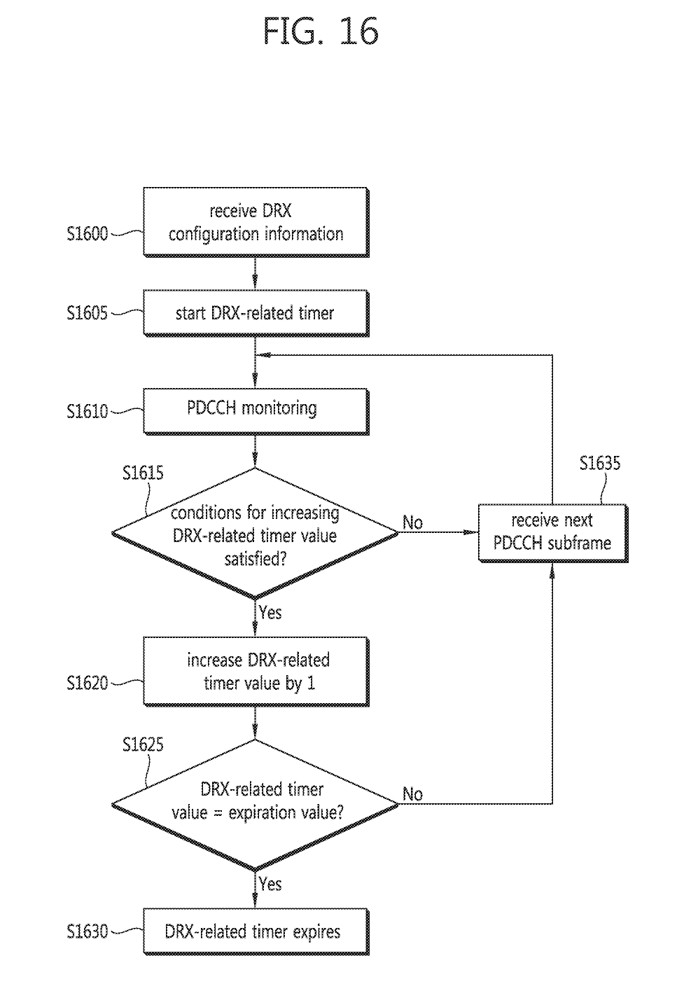

FIG. 16 is a flow chart illustrating a DRX operation performed by a UE according to an embodiment of the present invention. In this case, the DRX-related timer is an on-duration timer or a DRX inactivity timer.

Referring to FIG. 16, the UE receives DRX configuration information from the BS (S 1600).

The UE configures a DRX parameter in the US on the basis of the D DRX configuration information, and drives the DRX-related timer (S 1605). Here, the DRX-related timer includes an on-duration timer and a DRX inactivity timer. And, in step S 1605, it is is assumed that start conditions of the on-duration timer and the DRX inactivity timer are met.

Driving of the on-duration timer and the DRX inactivity timer means that the UE has entered the active time in the DRX cycle.

Thus, the UE may perform PDCCH monitoring (S1610). PDCCH monitoring, which corresponds to a case in which a corresponding subframe is a PDCCH subframe, may be performed when an exceptional situation in which the UE cannot perform PDCCH monitoring is excluded.

The UE checks whether conditions for increasing a DRX-related timer value are met (S 1615).

For example, according to the definition of a PDCCH subframe considering a key UL subframe, the conditions for increasing a DRX-related timer value may require that a corresponding subframe be a PDCCH subframe.

In another example, according to the definition of a PDCCH subframe without considering a key UL subframe, the conditions for increasing a DRX-related timer may require that a corresponding subframe be a PDCCH subframe (please see FIG. 8).

In yet another example, according to the definition of a PDCCH subframe without considering a key UL subframe, the conditions for increasing a DRX-related timer may require that a corresponding subframe should be a PDCCH subframe and there shouldn't be a transmission of high priority UL signal in the corresponding subframe (please see FIG. 7).

When the UE checks that the conditions for increasing the DRX-related timer value are met in step S 1615, the UE increases the timer value by 1(S 1620).

The UE checks whether the value of the DRX-related timer in a current subframe is equal to an expiration value previously set for the DRX-related timer (S 1625). When the timer is value is equal to the expiration value, the UE terminates the timer (S 1630).

In step S 1615, when the UE checks that conditions for increasing the timer value are not met, the UE maintains the DRX-related timer value and receives a next PDCCN subframe (S 1635).

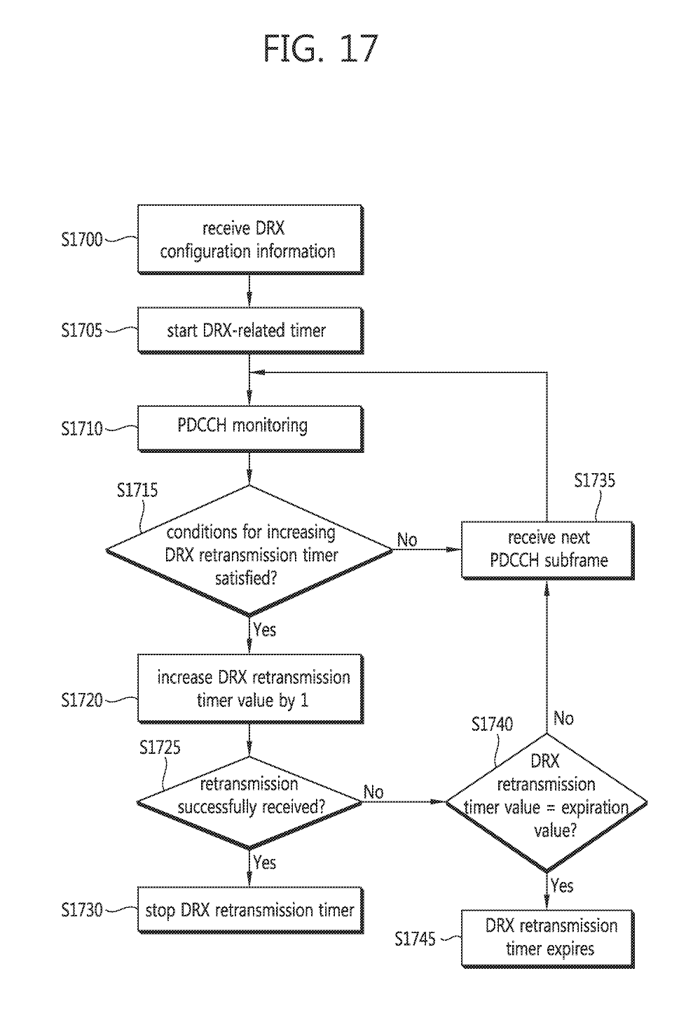

FIG. 17 is a flow chart illustrating a DRX operation performed by a UE according to another embodiment of the present invention. In this case, a DRX-related timer is a DRX retransmission timer.

Referring to FIG. 17, the UE receives DRX configuration information from the BS (S 1700).

The UE sets a DRX parameter on the basis of the DRX configuration information and drives the DRX retransmission timer (S 1705). Also, in step S 1705, it is assumed that conditions for starting the DRX retransmission timer are met. The conditions for increasing (or counting) the DRX retransmission timer are as follows.

For example, in a half-duplex UE operation, when the definition of a PDCCH subframe considering a key UL subframe is followed, the presence of a PDCCH subframe is required (please see FIGS. 9 and A)).

In another example, in the half-duplex UE operation, when the definition of a PDCCH subframe without considering a key UL subframe is followed, the presence of a PDCCH subframe is required (please see FIGS. 10 and B)).

In yet another example, in the half-duplex UE operation, when the definition of a PDCCH subframe without considering a key UL subframe is followed, the presence of a PDCCH subframe is required and there shouldn't be transmission of a high priority UL signal (please see FIGS. 11 and C)).

In yet another example, in the half-duplex UE operation, in case of considering self-scheduling, i) the HARQ RTT timer should expire, ii) a DL subframe or a special subframe should be configured in a scheduling cell with respect to a serving cell in which HARQ retransmission takes place, iii) there shouldn't be a reference cell determining a DL/UL direction and a UL subframe should not be configured through a different reference such as resource allocation directionality, or the like. After the DRX retransmission timer starts, when the conditions ii) and iii) are met, the UE increases the value of the DRX retransmission timer by 1. This resultantly requires that a PDCCH subframe be configured in every serving cell configured in the UE (please see D)).

In yet another example, in the half-duplex UE operation, in case of considering cross-carrier scheduling, the UE counts the DRX retransmission timer on the basis of the following conditions: i) the HARQ RTT timer should expire, ii), a DL subframe or a special subframe should be configured in a scheduling cell with respect to a secondary serving cell in which HARQ retransmission takes place, and iii) a DL subframe should be configured in a secondary serving cell in which HARQ retransmission takes place (please see (E)).

In yet another example, in the half-duplex UE operation, in case of considering cross-carrier scheduling, the UE counts the DRX retransmission timer on the basis of the following conditions: i) the HARQ RTT timer should expire, ii) a DL subframe or a special subframe should be configured in a scheduling cell with respect to a serving cell in which HARQ retransmission takes place, iii) a UL subframe should not be configured in a reference cell that determines DL/UL priority; iv) there shouldn't be transmission of a high priority UL signal, and v) UL retransmission should not take place in every serving cell. After the DRX retransmission timer starts, when the conditions ii), iii), iv), and v) are met, the UE increases a value of the DRX is retransmission timer by 1. This resultantly requires that a direction of the half-duplex UE be downlink, a current subframe be a PDCCH subframe, and a DL subframe or a special subframe be configured in a scheduling cell with respect to a serving cell in which HARQ retransmission takes place. Here, the entirety or some of the conditions iii), iv), and v) may be excluded in defining a PDCCH subframe (please see F)).

In yet another example, in a full-duplex UE operation, in case of considering cross-carrier scheduling, conditions for starting the DRX retransmission timer are as follows: i) the HARQ RTT timer should expire, and ii) decoding of data in a soft buffer related to the corresponding HARQ process should fail. Meanwhile, in order to increase a value of the DRX retransmission timer, a DL subframe or a special subframe is required to be configured in a scheduling cell with respect to a serving cell in which HARQ retransmission takes place. In other words, if a DL subframe is not configured or a special subframe does not exist in the scheduling cell of the serving cell in which HARQ retransmission takes place, a value of the DRX retransmission timer in the immediately previous subframe is maintained as is (please see FIG. 12).

In yet another example, in a full-duplex UE operation, in case of considering cross-carrier scheduling, conditions for starting the DRX retransmission timer are as follows: i) the HARQ RTT timer should expire, and ii) decoding of data in a soft buffer related to the corresponding HARQ process should fail. Meanwhile, in order to increase a value of the DRX retransmission timer, a DL subframe or a special subframe is required to be configured in a serving cell in which HARQ retransmission takes place. In other words, if a DL subframe is not configured or a special subframe does not exist in the serving cell in which HARQ retransmission takes place, a value of the DRX retransmission timer in the immediately previous subframe is maintained as is (please see FIG. 13).

In yet another example, in the full-duplex UE operation, in case of considering self-scheduling, conditions for starting the DRX retransmission timer are as follows: i) the HARQ RTT timer should expire, and ii) a DL subframe or a special subframe should be configured in a serving cell in which HARQ retransmission takes place (please see FIG. 14).

When the DRX retransmission timer is driven, it means that the UE has entered an active time in the DRX cycle.

Thus, the UE performs PDCCH monitoring in the PDCCH subframe (S 1710). PDCCH monitoring is performed when a PDCCH subframe exists.

The UE checks whether a PDCCH subframe has been configured in the serving cell in which HARQ retransmission or operation is performed (S 1715).

When it is ascertained by the UE that a PDCCH subframe has been configured in the serving cell in which HARQ retransmission or operation is performed, the UE increases the DRX retransmission timer value by 1 (S 1720).

The UE checks whether reception of HARQ retransmission has been successful (S1725). When the UE has successfully decoded HARQ downlink data (including PDCCH and PDSCH) retransmitted from the BS, the UE stops the DRX retransmissions timer (S 1730). When the UE fails to successfully decode HARQ downlink data (including PDCCH and PDSCH) retransmitted from the BS, the UE checks whether the DRX retransmission timer value is equal to a third expiration value (S 1740).

When the DRX retransmission timer value is equal to the third expiration value in step S 1740, the UE terminates the DRX retransmission timer (S 1745). Accordingly, the active time is terminated. Meanwhile, when the DRX retransmission timer value is not equal to the is third expiration value, the UE receives a next PDCCH subframe (S 1735).

In step S 1715, if a PDCCH subframe is not configured in the serving cell in which HARQ retransmission or operation is performed, or although a PDCCH subframe is configured, if the UE determines that subframe conflicting of a reference cell occurs, the UE maintains the DRX retransmission timer and receives a next PDCCH subframe (S 1735).

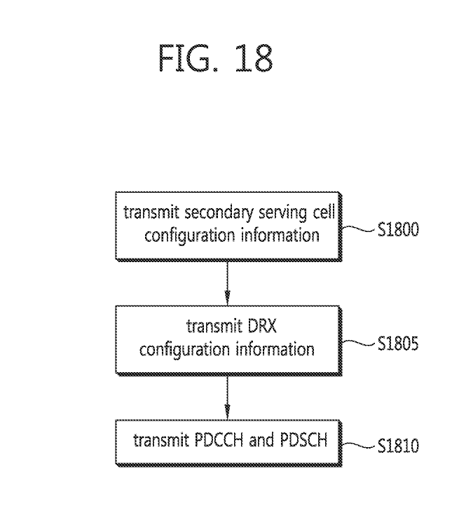

FIG. 18 is a flow chart illustrating a DRX operation performed by a BS according to an embodiment of the present invention.

Referring to FIG. 18, the BS transmits secondary serving cell configuration information (S 1800). The secondary serving cell configuration information, which is used to configure two or more serving cells in a UE supporting the multiple component carrier system, may be included in an RRC connection reconfiguration message and transmitted to the UE.

The BS transmits DRX configuration information to the UE (S 1805). The DRX configuration information is, for example, a set of parameters related to a DRX operation as described above with reference to Table 3.

The BS transmits a PDCCH and a PDSCH on a PDCCH subframe of at least one serving cell configured in the UE and activated (S 1810).

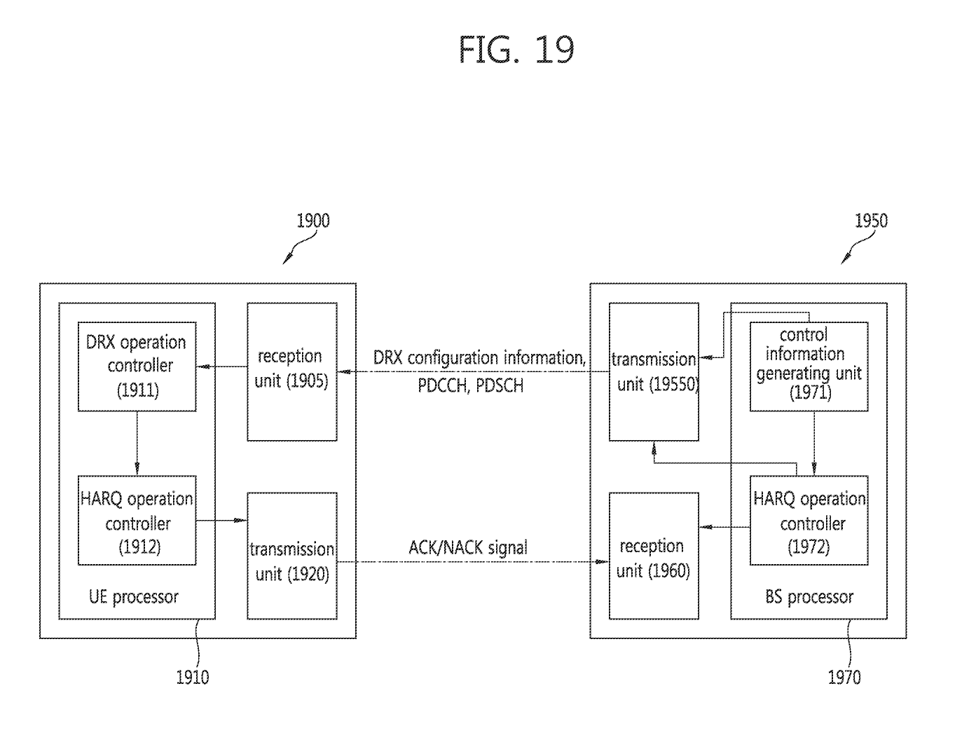

FIG. 19 is a block diagram of a UE and a BS performing a DRX operation according to an embodiment of the present invention.

Referring to FIG. 19, a UE 1900 includes a reception unit 1905, a UE process 1910, and a transmission unit 1920. The UE process 1910 includes a DRX operation controller 1911 and an HARQ operation controller 1912.

The reception unit 1905 receives DRX configuration information, a PDCCH, and a PDSCH from the BS. The PDCCH or the PDSCH may be received on any serving cell among is a plurality of serving cells configured in the 1900 or in any DL subframe or any special subframe.

The DRX operation controller 1911 sets a DRX-related timer on the basis of the DRX configuration information. The DRX-related timer includes an on-duration timer, a DRX inactivity timer, and a DRX retransmission timer. For example, the DRX operation controller 1911 may set a first expiration value of the on-duration timer to psf3, a second expiration value of the DRX inactivity timer to psf2, and a third expiration value of the DRX retransmission timer to psf4. As described above with reference to FIGS. 6 through 17, the DRX operation controller 1911 starts the DRX-related timer, increases a value of the DRX-related timer, stop the DRX-related timer, or terminates the DRX-related timer on the basis of conditions for starting the DRX-related timer, conditions for increasing a timer value, conditions for stopping the DRX-related timer, and conditions for terminating the DRX-related timer. The DRX operation controller 1911 manages an active time within a DRX cycle, determines whether a PDCCH subframe exists in a current TTI (transmission time interval) according to the foregoing definition of a PDCCH subframe, and monitors a PDCCH during the active time. The DRX operation controller 1911 may perform PDCCH monitoring when a corresponding subframe is a PDCCH subframe and when a situation is not an exceptional situation in which PDCCH monitoring cannot be performed. For example, as shown in the embodiment of FIG. 8, the DRX operation controller 1911 may monitor a PDCCH subframe on the basis of whether a high priority UL signal is transmitted in at least one of all serving cells configured in the UE 1900, in a current TTI or subframe.

When the DRX-related timer is an on-duration timer or a DRX inactivity timer, the DRX operation controller 1911 determines whether conditions for increasing a DRX-related is timer value are met, and when the conditions for increasing a DRX-related timer value are met, the DRX operation controller 1911 increases (or counts) the DRX-related timer.

For example, according to the definition of a PDCCH subframe considering a key UL subframe, the conditions for increasing a DRX-related timer value may require that a corresponding subframe be a PDCCH subframe.

In another example, according to the definition of a PDCCH subframe without considering a key UL subframe, the conditions for increasing a DRX-related timer may require that a corresponding subframe be a PDCCH subframe (please see FIG. 8).

In yet another example, according to the definition of a PDCCH subframe without considering a key UL subframe, the conditions for increasing a DRX-related timer may require that a corresponding subframe should be a PDCCH subframe and there shouldn't be a transmission of high priority UL signal in the corresponding subframe (please see FIG. 7).

Next, when the DRX-related timer is a DRX retransmission timer, the DRX operation controller 1911 determines whether the conditions for increasing the DRX retransmission timer value are met, and when the conditions for increasing the DRX retransmission timer value are met, the DRX operation controller 1911 increases the DRC retransmission timer.

For example, in a half-duplex UE operation, when the definition of a PDCCH subframe considering a key UL subframe is followed, the presence of a PDCCH subframe is required (please see FIGS. 9 and A)).

In another example, in the half-duplex UE operation, when the definition of a PDCCH subframe without considering a key UL subframe is followed, the presence of a PDCCH subframe is required (please see FIGS. 10 and B)).

In another example, in the half-duplex UE operation, when the definition of a PDCCH subframe without considering a key UL subframe is followed, the presence of a PDCCH subframe is required and there shouldn't be transmission of a high priority UL signal (please see FIGS. 11 and C)).

In yet another example, in the half-duplex UE operation, in case of considering self-scheduling, i) the HARQ RTT timer should expire, ii) a DL subframe or a special subframe should be configured in a scheduling cell with respect to a serving cell in which HARQ retransmission takes place, iii) there shouldn't be a reference cell determining a DL/UL direction and a UL subframe should not be configured through a different reference such as resource allocation directionality, or the like. After the DRX retransmission timer starts, when the conditions ii) and iii) are met, the DRX operation controller 1911 increases the value of the DRX retransmission timer by 1. This resultantly requires that a PDCCH subframe be configured in every serving cell configured in the UE (please see D)).

In yet another example, in the half-duplex UE operation, in case of considering cross-carrier scheduling, the DRX operation controller 1911 counts the DRX retransmission timer on the basis of the following conditions: i) the HARQ RTT timer should expire, ii), a DL subframe or a special subframe should be configured in a scheduling cell with respect to a secondary serving cell in which HARQ retransmission takes place, and iii) a DL subframe should be configured in a secondary serving cell in which HARQ retransmission takes place (please see (E)).

In yet another example, in the half-duplex UE operation, in case of considering cross-carrier scheduling, the DRX operation controller 1911 counts the DRX retransmission timer on the basis of the following conditions: i) the HARQ RTT timer should expire, ii) a DL subframe or a special subframe should be configured in a scheduling cell with respect to a serving cell in which HARQ retransmission takes place, iii) a UL subframe should not be configured in a reference cell that determines DL/UL priority; iv) there shouldn't be transmission of a high priority UL signal, and v) UL retransmission should not take place in every serving cell. After the DRX retransmission timer starts, when the conditions ii), iii), iv), and v) are met, the UE increases a value of the DRX retransmission timer by 1. This resultantly requires that a direction of the half-duplex UE be downlink, a current subframe be a PDCCH subframe, and a DL subframe or a special subframe be configured in a scheduling cell with respect to a serving cell in which HARQ retransmission takes place. Here, the entirety or some of the conditions iii), iv), and v) may be excluded in defining a PDCCH subframe (please see F)).

In yet another example, in a full-duplex UE operation, in case of considering cross-carrier scheduling, conditions for starting the DRX retransmission timer are as follows: i) the HARQ RTT timer should expire, and ii) decoding of data in a soft buffer related to the corresponding HARQ process should fail. Meanwhile, in order to increase a value of the DRX retransmission timer, a DL subframe or a special subframe is required to be configured in a scheduling cell with respect to a serving cell in which HARQ retransmission takes place. In other words, if a DL subframe is not configured or a special subframe does not exist in the scheduling cell of the serving cell in which HARQ retransmission takes place, the DRX operation controller 1911 maintains a value of the DRX retransmission timer as in the immediately previous subframe (please see FIG. 12).

In yet another example, in a full-duplex UE operation, in case of considering cross-carrier scheduling, conditions for starting the DRX retransmission timer are as follows: i) the HARQ RTT timer should expire, and ii) decoding of data in a soft buffer related to the corresponding HARQ process should fail. Meanwhile, in order to increase a value of the DRX retransmission timer, a DL subframe or a special subframe is required to be configured in a serving cell in which HARQ retransmission takes place. In other words, if a DL subframe is not configured or a special subframe does not exist in the serving cell in which HARQ retransmission takes place, the DRX operation controller 1911 maintains a value of the DRX retransmission timer as in the immediately previous subframe (please see FIG. 13).

In yet another example, in the full-duplex UE operation, in case of considering self-scheduling, conditions for starting the DRX retransmission timer are as follows: i) the HARQ RTT timer should expire, and ii) a DL subframe or a special subframe should be configured in a serving cell in which HARQ retransmission takes place (please see FIG. 14).

The HARQ operation controller 1912 checks whether the PDCCH received by the reception unit 1905 from a BS 1950 indicates that there is downlink data transmission. This is the same with a case in which the HARQ operation controller 1912 knows that there is downlink data transmission in advance through semi-persistent scheduling (SPS). The HARQ operation controller 1912 checks whether a carrier indication field (CIF) exists in the PDCCH. When a CIF exists, the HARQ operation controller 1912 checks for which serving cells the PDCCH serves on the basis of the CIF. Thereafter, the HARQ operation controller 1912 starts the HARQ RTT timer related to a specific HARQ process according to HARQ entity information in the PDCCH. In case of the SPS, the HARQ operation controller 1912 starts the HARQ RTT timer related to a specific HARQ process according to pre-set HARQ entity information.

The transmission unit 1920 transmits an ACK/NACK signal generated by the HARQ operation controller 1912 to the BS 1950.

The BS 1950 includes a transmission unit 1955, a reception unit 1960, and a BS is processor 1970. The BS processor 1970 includes a control information generating unit 1971 and HARQ operation controller 1972.

The transmission unit 1955 transmits DRX configuration information, a PDCCH subframe, and a PDSCH to the UE 1900. In particular, the transmission unit 1955 configures a PDCCH subframe in a time division duplex mode, and transmits the PDCCH subframe to the UE 1900 during an active time of a DRX cycle.

The reception unit 1960 receives the ACK/NACK signal from the UE 1900.

The control information generating unit 1971 generates a DRX configuration information such as that shown in Table 2, for example, and transmits the generated DRX configuration to the transmission unit 1955. Also, the control information generating unit 1971 generates DL control information mapped to a PDCCH.

When the reception unit 1960 receives a NACK signal from the UE 1900 in response to DL data transmitted by the transmission unit 1955 to the UE 1900, the HARQ operation controller 1972 manages a corresponding HARQ process number and controls an HARQ operation such that HARQ retransmission data may be retransmitted to the UE 1900 within a maximum number of retransmission. Also, the HARQ operation controller 1972 may count a DRX-related timer included in the active time in the PDCCH subframe. The HARQ operation controller 1972 may increase a value of the DRX-related timer by 1 each time in every PDCCH subframe.

According to embodiments of the present invention, since a PDCCH subframe with respect to a half-duplex UE operation and a full-duplex UE operation is defined from a vantage point of a plurality of serving cells, a PDCCH monitoring and DRX operation performing method of a UE can be clarified.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method for a discontinuous reception (DRX) operation by a half-duplex user equipment (UE) in a multiple component carrier system, the method comprising:
performing physical downlink control channel (PDCCH) monitoring on a PDCCH subframe during an active time of a DRX cycle in a time division duplex mode; and
counting a DRX-related timer included in the active time in the PDCCH subframe,
wherein the PDCCH subframe includes a subframe in case that a primary serving cell, among all serving cells configured in the UE, is a downlink (DL) subframe or a special subframe.

2. The method of claim 1, wherein, in the counting of the DRX-related timer, a value of the DRX-related timer is increased by 1 per PDCCH subframe.

3. The method of claim 1, wherein the PDCCH monitoring is performed when an uplink (UL) signal is not transmitted in the PDCCH subframe.

4. The method of claim 3, wherein the UL signal is a physical random access channel (PRACH).

5. A half-duplex user equipment (UE) performing a DRX (discontinuous reception) operation in a multiple component carrier system, the half-duplex UE comprising:
a DRX operation controller configured to perform physical downlink control channel (PDCCH) monitoring on a PDCCH subframe during an active time of a DRX cycle, and count a DRX-related timer included in the active time in the PDCCH subframe; and
a reception unit configured to receive a PDCCH from a base station (BS) to perform the PDCCH monitoring,
wherein the PDCCH subframe includes a subframe in case that a primary serving cell, among all serving cells configured in the UE, is a downlink (DL) subframe or a special subframe.

6. The half-duplex UE of claim 5, wherein the DRX operation controller increases a value of the DRX-related timer by 1 per PDCCH subframe.

7. The half-duplex UE of claim 5, wherein when an uplink (UL) signal is not transmitted in the PDCCH subframe, the DRX operation controller performs the PDCCH monitoring.

8. The half-duplex UE of claim 7, wherein the UL signal is a physical random access channel (PRACH).

9. A method for controlling a discontinuous reception (DRX) operation of a half-duplex user equipment (UE) by a base station (BS) in a multiple component carrier system, the method comprising:
configuring a physical downlink control channel (PDCCH) subframe in a time division duplex mode;
transmitting the PDCCH subframe to the UE during an active time of a DRX cycle; and
counting a DRX-related timer included in the active time in the PDCCH subframe,
wherein the PDCCH subframe includes a subframe in case that a primary serving cell, among all serving cells configured in the UE, is a downlink (DL) subframe or a special subframe.

10. The method of claim 9, wherein in the counting of the DRX-related timer, a value of the DRX-related timer is increased by 1 per PDCCH subframe.

11. The method of claim 9, wherein when an uplink (UL) signal is not transmitted in the PDCCH subframe, the PDCCH monitoring is performed by the UE.

12. The method of claim 11, wherein the UL signal is a physical random access channel (PRACH).

13. A base station (BS) for controlling a DRX (discontinuous reception) operation of a half-duplex user equipment (UE) in a multiple component carrier system, the BS comprising:
a transmission unit configured to configure a physical downlink control channel (PDCCH) subframe and transmit the PDCCH subframe to the UE during an active time of a DRX cycle, in a time division duplex mode; and
an HARQ operation controller configured to count a DRX-related timer included in the active time in the PDCCH subframe,
wherein the PDCCH subframe includes a subframe in case that a primary serving cell, among all serving cells configured in the UE, is a downlink (DL) subframe or a special subframe.

14. The base station of claim 13, wherein the HARQ operation controller increases a value of the DRX-related timer by 1 per PDCCH subframe.

15. The base station of claim 13, wherein when an uplink (UL) signal is not transmitted in the PDCCH subframe, the PDCCH monitoring is performed by the UE.
